(19) United States
(12) Patent Application Publication
(10) Pub. No.: US 2023/0078346 A1
(43) Pub. Date: Mar. 16, 2023

(54) METHOD AND APPARATUS FOR MANUFACTURING PAPER STRAWS

(71) Applicant: NOVACART S.P.A., Garbagnate Monastero (LC) (IT)

(72) Inventor: Gianmario ANGHILERI, Malgrate (LC) (IT)

(73) Assignee: NOVACART S.P.A., Garbagnate Monastero (LC) (IT)

(21) Appl. No.: 17/800,855

(22) PCT Filed: Feb. 18, 2021
(86) PCT No.: PCT/IB2021/051385

§ 371 Date: Aug. 18, 2022

(30) Foreign Application Priority Data
Feb. 18, 2020 (IT) 102020000003296

(51) Int. Cl. B31C 1/08

(52) U.S. Cl. CPC B31C 1/08

(57) ABSTRACT

A method for manufacturing straws includes the steps of predisposing a web or a discrete sheet of sheet material, wherein the web or discrete sheet extends between an end portion and tail portion; predisposing a winding body extending along an axis; completely winding the web or discrete sheet around the winding body for defining a cylindrical body of sheet material wherein the end portion and tail portion face each other for defining a mutual overlapping portion; and constraining the end portion to the tail portion in the mutual overlapping portion in order to define a straw extending between a first and second substantially circular free edges, wherein the mutual overlapping portion extends between the first and second free edges of the straw along a rectilinear direction.

### FIELD OF THE INVENTION

The present invention refers to a method and apparatus for manufacturing paper straws. More particularly, the invention refers to a small tabletop machine for manufacturing paper straws and the associated manufacturing method. Therefore, the invention finds an application in the catering, food, and beverage fields.

### State of the Art

Industrial apparatuses for manufacturing paper straws, wherein a paper web, unwound from a reel, is wrapped plural times by following a spiral direction around a central body in order to define a straw, are known in the food and beverage fields. Patent document TWM543012U describes a system for manufacturing straws of paper material, wherein a web is repeatedly wound around a central core, in order to define a paper cylinder having a spiral structure. The end portions of the edges of the rolled web are mutually overlapped in order to enable a reciprocal engagement by a heat-sealing process. The manufacturing method and apparatus enable a high productivity and are destined to manufacture huge quantities of straws in the industrial sector. The Applicant points out that the method of manufacturing spiral straws requires a large-size apparatus, suitable for industrial fields but not suitable for being used in normal places, such as for example catering or private premises. Such method requires a continuous operation of the apparatus, making it adapted in sectors requiring a high productivity: such method and apparatus therefore are not adapted for manufacturing a single straw on customer demand. The apparatuses for manufacturing straws by spirally winding them require to continuously overlap lateral portions of the web: this entails, from one side, a substantial consumption of material, and from the other side, the use of professional manufacturing machines being capable of increasing the hourly productivity and consequently reducing the unit cost of the product in order to sell it. This involves both an increase of the consumption of the required material, and the necessity to have a high productivity in order capable of meeting high sale volumes.

Document CH264925A refers to a method and a device for manufacturing tubular bodies by winding a sheet material. The sheet material is wrapped around a cylindrical body having a predefined diameter and length, for example having a diameter of 2.5 cm and a length of 20 cm. During the winding step, the sheet material is guided by further rotatively movable rolls arranged laterally to the cylindrical body. A further lateral heatable roll is movable towards the cylindrical body for sealing the sheet material. Ejecting the wound straw, during the final manufacturing step, around a tubular body, is often troublesome due to a resistance between the inner surface of the straw and the outer lateral surface of the tubular body. For this reason, damages to the straw material can be easily formed during the straw ejecting step: moreover, possibly the straw definitively jams around the tubular body, determining the necessity of a maintenance action enabling to manually remove the straw from the apparatus.

Document BE492057A shows an apparatus for manufacturing stiff multilayer tubes of paperboard by winding a paperboard sheet unwound from a reel, on a cylindrical core provided with an insertion lead-in seat. The paperboard sheet is firstly impregnated by glue and then is wound in plural layers and pressed for defining a finished product.

Document JPS60212338 shows a further apparatus for manufacturing paperboard multilayer stiff tubes.

### OBJECT OF THE INVENTION

It is an object of the present invention to substantially solve at least one of the beforehand inconveniences and/or limitations.

A first object of the present invention provides a method and an apparatus suitable to manufacture a small number of paper straws, particularly to manufacture single straws according to each need of a customer.

A further object of the invention provides a method and an apparatus apt to enable to easily eject the straw, reducing the risk of possible damages to the straw and possible downtimes caused by a failed ejection.

A further object of the invention provides a method and apparatus adapted to manufacture straws of paper material devoid of portions of material emerging inside the cylindrical body.

A further object of the invention provides a method and an apparatus adapted to reduce the material consumption during a manufacturing cycle of each single straw.

A further object of the invention provides a method and an apparatus sufficiently adaptable to enable to manufacture single straws possibly having different sizes, as required by a customer.

A further object of the invention provides a manufacturing paper straws apparatus having a compact size and a light weight, particularly an apparatus easily portable by hand.

It is also an object to provide an apparatus having a low initial purchasing cost, so that the straw cost will be low, and most of all ensuring sterility by uncontaminated straws.

Another object consists of arousing interest and curiosity also in an educational way in a possible customer.

A further object of the invention provides an apparatus for manufacturing paper straws, which can be easily operated by a user (for example directly by a customer of a catering service) not skilled in the field of manufacturing straws.

### BRIEF DESCRIPTION OF THE DRAWINGS

Some embodiments and some aspects of the invention will be described in the following with reference to the attached drawings, given only in an indicative and consequently non-limiting way, wherein:

FIGS. 1 and 2 are perspective views of an apparatus for manufacturing straws according to the present invention;

FIG. 3 is a top view of an apparatus for manufacturing straws according to the present invention;

FIG. 4 is a cross-section view of FIG. 3;

FIG. 5 is a detailed view of a winding body of a straw manufacturing apparatus according to the present invention;

FIG. 5A is a cross-section view of FIG. 5;

FIGS. from 6 to 10 show sequential steps of manufacturing straws according to the present invention;

FIG. 11 is a detailed view of an ejecting station of a straw manufacturing apparatus according to the present invention;

FIGS. 12, 13 and 14 show steps of ejecting a straw according to the present invention;

FIG. 15 is a perspective view of a straw made by an apparatus and by a method according to the present invention.

In the present detailed description corresponding parts illustrated in different figures are indicated by the same numeral references. Figures could illustrate the object of the invention by not-to-scale representations; consequently, parts and components illustrated in the figures associated to the object of the invention could refer only to schematic representations.

Control Unit

The apparatus herein described and claimed comprises at least one control unit responsible of controlling the operations implemented by the apparatus. Obviously, the control unit can be just one or can be formed by a plurality of distinct control units according to design choices and operative needs.

The term “control unit” means an electronic-type component which can comprise at least one of: a digital processor (comprising at least one selected in the group of: CPU, GPU, GPGPU, for example), a memory (or memories), an analog-type circuit, or a combination of one or more digital processing units with one or more analog-type circuits. The control unit can be “configured” or “programmed” to perform some steps: this can be actually made by any means enabling to configure or program the control unit. For example, if a control unit comprises one or more CPUs and one or more memories, one or more programs can be stored on suitable memory banks connected to the CPU or CPUs; the program or programs contain instructions which, when run in the CPU or CPUs, program or configure the control unit to perform the operations described with reference to the control unit. Alternatively, if the control unit is or comprises an analog-type circuitry, therefore the circuit of the control unit can be designed to include a circuitry configured, in use, to process electrical signals in order to perform the steps associated to the control unit. The control unit can comprise one or more digital units, for example of the microprocessor type, or one or more analog units, or a suitable combination of digital and analog units; the control unit can be configured to coordinate all the actions required to execute an instruction and sets of instructions.

Motor/Actuator

The term “actuator” means any device capable of causing a movement on a body, for example by a command from the control unit (the motor receives a command output by the control unit). The motor can be a DC or AC electric motor having characteristics of power, speed, and torque which depend on design requirements. The motor can define a rotative motion and comprise a reducer, for example formed by one or more gears interconnected to each other: the reducer can be a speed reducer in order to increase the output motive torque. Moreover, the motor can impart to a body a linear or rectilinear motion. Further, the motor can be actuated by a spring, for example a preloaded torsion spring.

The term “actuator” means any device capable of imparting a motion to a body, for example by a command from the control unit (the actuator receives a command output by the control unit). The actuator can be of an electric-, pneumatic-, mechanical-type (e.g.: a spring), or of any other type. The actuator can impart a linear, rectilinear, or circular motion. Moreover, the actuator can comprise a reducer, for example formed by one or more gears interconnected to each other: the reducer can be a speed reducer in order to increase the supplied motive torque or force.

### ASPECTS OF THE INVENTION

An aspect refers to a method for manufacturing straws (50) comprising the following steps:
predisposing a web or at least one discrete sheet (1a, 1b) of paper material, said web or discrete sheet extending at least between an end portion (2) and a tail portion (3);
predisposing a winding body (11) extending along an axis (A) and rotatively movable around said axis (A), the winding body (11) comprising at least one groove (13) extending along said axis (A) in order to define a hollow seat;
winding said web or discrete sheet (1a, 1b) around the winding body (11) for defining a cylindrical body (5) of paper material, wherein the end portion (2) and the tail portion (3) reciprocally face in order to define a mutual overlapping portion (4), optionally said end and tail portions (2, 3) being substantially parallel to the axis (A) of the winding body (11);
constraining the end portion (2) to the tail portion (3) at the mutual overlapping portion (4) for defining a straw (50) extending between a first and a second substantially circular free edges (51, 52), optionally said mutual overlapping portion (4) extending between the first and the second free edges (51, 52) of the straw (50) along a rectilinear direction.

A further aspect refers to an apparatus (100) for manufacturing straws comprising a support structure (60) defining an inner volume and supporting:
a supply station (30) configured to provide a web (1a) or at least one discrete sheet (1b) of paper material, said web or discrete sheet having at least one end portion (2) and a tail portion (3);
a forming station (10) comprising at least one winding body (11) extending along an axis (A) and configured to receive by winding said web or discrete sheet (1a, 1b), in order to define a cylindrical body (5) of paper material, wherein the end portion (2) and tail portion (3) reciprocally face for defining a mutual overlapping portion (4), optionally said end and tail portions being substantially parallel to the axis (A) of the winding body (11);
a constraining station (20) configured to constrain the end portion (2) to the tail portion (3) at the mutual overlapping portion (4) in order to define a straw (50) extending between a first and second substantially circular free edges (51, 52), optionally said mutual overlapping portion (4) extending between the first and second free edges (51, 52) of the straw (50) along a rectilinear direction.

A 1st aspect refers to a method for manufacturing straws (50) comprising the following steps:
providing a web or at least one discrete sheet (1a, 1b) of paper material, said web or discrete sheet extending at least between an end portion (2) and a tail portion (3);
providing a winding body (11) extending along an axis (A) and rotatively movable around said axis (A), the winding body (11) comprising at least one groove (13) extending along said axis (A) in order to define a hollow seat;
winding said web or discrete sheet (1a, 1b) around the winding body (11) for defining a cylindrical body (5) of paper material, wherein the end portion (2) and the tail portion (3) face each other for defining a mutual overlapping portion (4), optionally said end and tail portions (2, 3) being substantially parallel to the axis (A) of the winding body (11);
constraining the end portion (2) to the tail portion (3) at the mutual overlapping portion (4) for defining a straw (50) extending between a first and second substantially circular free edges (51, 52), said mutual overlapping portion (4) extending between the first and the second free edges (51, 52) of the straw (50) along a rectilinear direction, wherein said winding step comprises at least the following steps:
approaching the end portion (2) of the web or discrete sheet (1a, 1b) to the winding body (11);
inserting at least part of the end portion (2) in the groove (13) of the winding body (11);
following the inserting step, rotating the winding body (11) around the axis (A) and simultaneously thrusting said web or discrete sheet (1a, 1b) towards the winding body (11) for determining the winding.

A 2nd aspect relates to a method for manufacturing straws (50) comprising the following steps:
providing a web or at least one discrete sheet (1a, 1b) of paper material, said web or discrete sheet extending at least between an end portion (2) and a tail portion (3);
providing a winding body (11) extending along an axis (A) and rotatively movable around said axis (A), the winding body (11) comprising at least one groove (13) extending along said axis (A) and being arranged on a lateral surface (12) of the winding body (11) for defining a hollow seat;
winding said web or discrete sheet (1a, 1b) around the winding body (11) for defining a cylindrical body (5) of paper material, wherein the end portion (2) and tail portion (3) face each other for defining a mutual overlapping portion (4), optionally said end and tail portions (2, 3) being substantially parallel to the axis (A) of the winding body (11);
constraining the end portion (2) to the tail portion (3) at the mutual overlapping portion (4) for defining a straw (50) extending between a first and a second substantially circular free edges (51, 52),
   said mutual overlapping portion (4) extending between the first and the second free edges (51, 52) of the straw (50) along a rectilinear direction,
   the method further comprising a step of ejecting the straw (50) following the constraining step, said ejecting step providing to move the straw (50) along the axis (A) of the winding body (11) between:
a first position wherein the straw (50) surrounds the winding body (11); and
a second position wherein at least part of the straw (50) exceeds beyond the extension in length of the winding body (11),
   the step of moving the straw (50) providing to actuate an ejection wheel (113) having an axis of rotation (R) substantially orthogonal to the axis (A) of the winding body (11), said ejection wheel (113) being further movable with respect to the winding body (11) between a distal position and an approached position, said ejecting step comprising the steps of:
moving the ejection wheel (113) from the distal position to the approached position, the sheet material of the straw (50) being interposed in contact between said ejection wheel (113) and the winding body (11);
putting in rotation said ejection wheel (113) around its axis of rotation (R) for moving the straw (50) along the axis (A) of the winding body (11) in order to determine its ejection;
optionally, moving the ejection wheel (113) from the approached position to the distal position.

A 3rd aspect relates to a method for manufacturing straws (50) comprising the following steps:
providing a web or at least one discrete sheet (1a, 1b) of paper material, said web or discrete sheet extending at least between an end portion and a tail portion (3);
providing a winding body (11) extending along an axis (A) and rotatively movable around said axis (A), the winding body (11) having a cross-section, according to a plane orthogonal to the axis (A), comprising a first optionally semi-circular outline (11a), defining a first radius or a first distance D1 from the axis (A), and a second outline (11b), particularly rectilinear, concave or convex, defining a second distance D2 from the axis (A), the first distance D1 being greater than the second distance D2;
winding said web or discrete sheet (1a, 1b) around the winding body (11) for defining a cylindrical body (5) of paper material, wherein the end portion (2) and the tail portion (3) face each other for defining a mutual overlapping portion (4), optionally said end and tail portions (2, 3) being substantially parallel to the axis (A) of the winding body (11);
constraining the end portion (2) to the tail portion (3) at the mutual overlapping portion (4) for defining a straw (50) extending between a first and a second substantially circular free edges (51, 52), said mutual overlapping portion (4) extending between the first and the second free edges (51, 52) of the straw (50) along a rectilinear direction,
   wherein the straw (50) has a cylindrical shape defining an inner circumference IC,
   the sum of an extension in length of said first and second outlines (11a, 11b) defining a dimension L lower than said inner circumference IC of the straw (50), particularly wherein 0.5*IC<L<0.98*IC, more particularly wherein 0.71C<L<0.95*IC.

A 4th aspect refers to an apparatus (100) for manufacturing straws comprising a support structure (60), defining an inner volume, and supporting:
a supply station (30) configured to provide a web (1a) or at least one discrete sheet (1b) of paper material, said web or discrete sheet having at least one end portion (2) and a tail portion (3);
a forming station (10) comprising at least one winding body (11) extending along an axis (A) and configured to receive by winding said web or discrete sheet (1a, 1b), for defining a cylindrical body (5) of paper material, wherein the end portion (2) and the tail portion (3) face each other for defining a mutual overlapping portion (4), optionally said end and tail portions being substantially parallel to the axis (A) of the winding body (11);
a constraining station (20) configured to constrain the end portion (2) to the tail portion (3) at the mutual overlapping portion (4) for defining a straw (50) extending between a first and a second substantially circular free edges (51, 52), said mutual overlapping portion (4) extending between the first and the second free edges (51, 52) of the straw (50) along a rectilinear direction,
wherein the winding body (11) has a lateral surface (12) comprising at least one first surface (12a), and at least one second surface (12b) both extending along the axis (A) of the winding body, wherein the first surface (12a) of the lateral surface (12) has a first distance D1 from the axis (A) of the winding body (11), the second surface (12b) of the lateral surface (12) of the winding body (11) having a second distance D2 from the same axis (A), the first distance D1 being greater than the second distance D2.

A 5th aspect relates to an apparatus (100) for manufacturing straws comprising a support structure (60), defining an inner volume, and supporting:
a supply station (30) configured to predispose a web (1a) or at least one discrete sheet (1b) of paper material, said web or discrete sheet having at least one end portion (2) and a tail portion (3);
a forming station (10) comprising at least one winding body (11) extending along an axis (A) and configured to receive by winding said web or discrete sheet (1a, 1b), for defining a cylindrical body (5) of paper material, wherein the end portion (2) and the tail portion (3) face each other for defining a mutual overlapping portion (4), optionally said end and tail portions being substantially parallel to the axis (A) of the winding body (11);
the winding body (11) comprising at least one groove (13) extending along said axis (A) in order to define a hollow seat;
a constraining station (20) configured to constrain the end portion (2) to the tail portion (3) at the mutual overlapping portion (4) for defining a straw (50) extending between a first and a second substantially circular free edges (51, 52), said mutual overlapping portion (4) extending between the first and the second free edges (51, 52) of the straw (50) along a rectilinear direction, at least one pusher (15) configured to determine the advancement of said web or discrete sheet (1a, 1b) towards the winding body (11);
a control unit (70) connected to the winding body (11) and to the at least one pusher (15) and configured to perform the following steps:
commanding the at least one pusher (15) to move the web (1a) towards the winding body (11) and determining the insertion of at least part of the end portion (2) into the groove (13) of the winding body (11);
following the insertion, rotating the winding body (11) around the axis (A) and simultaneously thrusting, by the pusher (15), said web or discrete sheet (1a, 1b) towards the winding body (11) for determining the winding.

A 6th aspect relates to an apparatus (100) for manufacturing straws comprising a support structure (60), defining an inner volume, and supporting:
a supply station (30) configured to provide a web (1a) or at least one discrete sheet (1b) of paper material, said web or discrete sheet having at least one end portion (2) and a tail portion (3);
a forming station (10) comprising at least one winding body (11) extending along an axis (A) and configured to receive by winding said web or discrete sheet (1a, 1b), for defining a cylindrical body (5) of paper material, wherein the end portion (2) and the tail portion (3) face each other for defining a mutual overlapping portion (4), optionally said end and tail portions being substantially parallel to the axis (A) of the winding body (11);
a constraining station (20) configured to constrain the end portion (2) to the tail portion (3) at the mutual overlapping portion (4) for defining a straw (50) extending between a first and second substantially circular free edges (51, 52), said mutual overlapping portion (4) extending between the first and the second free edges (51, 52) of the straw (50) along a rectilinear direction,
an ejection wheel (113) having an axis of rotation (R) substantially orthogonal to the axis (A) of the winding body (11), said ejection wheel (113) being further movable with respect to the winding body (11) between a distal position and an approached one,
a control unit connected at least to the ejection wheel (113) and configured to:
move the ejection wheel (113) from the distal position to the approached position, the ejection wheel being configured to contact, when arranged in said approached position, the sheet material of the straw (50) interposed in contact between said ejection wheel (113) and the winding body (11);
put in rotation said ejection wheel (113) around its axis of rotation (R) for moving the straw (50) along the axis (A) of the winding body (11) in order to determine its ejection;
optionally move the ejection wheel (113) from the approached position to the distal position.

A 7th aspect relates to an apparatus (100) for manufacturing straws comprising a support structure (60), defining an inner volume, and supporting:
a supply station (30) configured to unwind a web (1a) of paper material along an unwinding direction (UD), said web extending between at least one end portion (2) and a tail portion (3);
a cutting station (40) comprising at least one cutting tool particularly selected between a rotating or translating blade, said cutting station (40) being configured to define a cut on at least one web portion (1a) for defining a discrete sheet (1b), said cut being transversal, optionally orthogonal, with respect to the unwinding direction (UD) of the web (1a),
a forming station (10) comprising at least one winding body (11) extending along an axis (A) and configured to receive by winding said web and/or discrete sheet (1a, 1b), for defining a cylindrical body (5) of paper material, wherein the end portion (2) and the tail portion (3) face each other for defining a mutual overlapping portion (4), optionally said end and tail portions being substantially parallel to the axis (A) of the winding body (11);
a constraining station (20) configured to constrain the end portion (2) to the tail portion (3) at the mutual overlapping portion (4) for defining a straw (50) extending between a first and a second substantially circular free edges (51, 52), said mutual overlapping portion (4) extending between the first and the second free edges (51, 52) of the straw (50) along a rectilinear direction,
   wherein said winding body (11) has a radial size defining an outer circumference EC, the cutting station, particularly the cutting tool, being arranged at a cutting distance CD from the winding body (11), wherein 0.25*EC<CD<EC.

In a further aspect according to any one of the preceding aspects, the step of winding said web or discrete sheet (1a, 1b) around the winding body (11) for defining a cylindrical body (5) of paper material wherein the end portion (2) and the tail portion (3) face each other for defining a mutual overlapping portion (4), is a step wherein the obtained cylindrical body is made by a single layer except for the mutual overlapping portion (4) wherein the end portion (2) and the tail portion (3) overlap and are directly in contact to define a two-layer zone.

In an 8th aspect according to any one of the preceding aspects, the winding step comprises at least the following steps:

approaching the end portion (2) of the web or discrete sheet (1a, 1b) to the winding body (11);

inserting at least part of the end portion (2) into the groove (13) of the winding body (11);

after the inserting step, rotating the winding body (11) around the axis (A) and simultaneously thrusting said web or discrete sheet (1a, 1b) towards the winding body (11) for determining the winding step.

In a 9th aspect according to any one of the preceding aspects, wherein the method further comprises a step of ejecting the straw (50) following the constraining step, said ejecting step providing to move the straw (50) along the axis (A) of the winding body (11) between:
a first position wherein the straw (50) surrounds the winding body (11); and
a second position wherein at least part of the straw (50) exceeds beyond the extension in length of the winding body (11).

In a 10th aspect according to the preceding aspect, the step of moving the straw (50) provides to actuate an ejection wheel (113) having an axis of rotation (R) substantially orthogonal to the axis (A) of the winding body (11).

In an 11th aspect according to the two preceding aspects, wherein said ejection wheel (113) is movable with respect to the winding body (11) between a distal position and an approached position, said ejecting step comprising the steps of:
moving the ejection wheel (113) from the distal position to the approached position, the sheet material of the straw (50) being interposed in contact between said ejection wheel (113) and the winding body (11);
putting in rotation said ejection wheel (113) around its axis of rotation (R) to move the straw (50) along the axis (A) of the winding body (11) in order to determine its ejection;
optionally moving the ejection wheel (113) from the approached position to the distal position.

In a 12th aspect according to any one of the preceding aspects, the winding body (11) has a cross-section, according to a plane orthogonal to the axis (A), comprising a first outline (11a) optionally semi-circular, defining a first radius or first distance (D1) from the axis (A), and a second outline (11b), particularly rectilinear, concave or convex, defining a second distance (D2) from the axis (A), the first distance (D1) being greater than the second distance (D2).

In a 13th aspect according to the preceding aspect, the straw (50) has a cylindrical shape defining an inner circumference IC, the sum of a longitudinal extension of said first and second outlines (11a, 11b) defining a dimension L lower than said inner circumference IC of the straw (50), particularly wherein 0.5*IC<L<0.98*IC, more particularly wherein 0.7*IC<L<0.95*IC.

In a 14th aspect according to any one of the preceding aspects, the winding body (11) has a lateral surface (12) comprising at least one first surface (12a), and at least one second surface (12b) both extending along the axis (A) of the winding body, wherein the first surface (12a) of the lateral surface (12) has a first distance D1 from the axis (A) of the winding body (11), the second surface (12b) of the lateral surface (12) of the winding body (11) having a second distance D2 from the same axis (A), the first distance D1 being greater than the second distance D2.

In a 15th aspect according to any one of the preceding aspects, wherein the apparatus comprises at least one pusher (15) configured to cause the advancement of said web or discrete sheet (1a, 1b) towards the winding body (11).

In a 16th aspect according to the preceding aspect, the apparatus comprises a control unit (70) connected to the winding body (11) and to the at least one pusher (15) and configured to perform the following steps: commanding the at least one pusher (15) to move the web (1a) towards the winding body (11) and determining the insertion of at least part of the end portion (2) into the groove (13) of the winding body (11); after the insertion, rotating the winding body (11) about the axis (A) and simultaneously thrusting, by means of the pusher (15), said web or discrete sheet (1a, 1b) towards the winding body (11) for determining the winding.

In a 17th aspect according to any one of the preceding aspects, the apparatus comprises an ejection wheel (113) having an axis of rotation (R) substantially orthogonal to the axis (A) of the winding body (11), said ejection wheel (113) being further movable with respect to the winding body (11) between a distal position and an approached one.

In an 18th aspect according to the preceding aspect, the apparatus comprises a control unit connected at least to the ejection wheel (113) and configured to: move the ejection wheel (113) from the distal position to the approached position, the ejection wheel being configured to contact, when arranged in said approached position, the sheet material of the straw (50) interposed in contact between said ejection wheel (113) and the winding body (11); put in rotation said ejection wheel (113) around its axis of rotation (R) for moving the straw (50) along the axis (A) of the winding body (11) in order to determine its ejection; optionally moving the ejection wheel (113) from the approached position to the distal position.

In a 19th aspect according to any one of the preceding aspects, said winding body (11) has a radial size defining an outer circumference EC, the cutting station, particularly the cutting tool, being arranged at a cutting distance CD from the winding body (11), wherein 0.25*EC<CD<EC.

In a 20th aspect according to any one of the preceding aspects, the step of rotating the winding body (11) comprises:
a first rotation for defining a partial winding of the web or discrete sheet around the winding body (11), said first rotation being particularly comprised between 45° and 315°, particularly comprised between 90° and 270°, still more particularly comprised between 170° and 200°, preferably comprised between 182° and 190°;
a second rotation, following and additional to said first rotation, for defining a complete winding of the web or discrete sheet (1a, 1b) around the winding body (11), said complete winding defining the cylindrical body (5) and mutual overlapping portion (4);

said thrusting step being simultaneous to said first rotation.

In a 21st aspect according to the preceding aspect, the sum of the first and second rotations defines an angle comprised between 361° and 540°, particularly comprised between 400° and 500°, preferably comprised between 470° and 480°.

In a 22nd aspect according to the two preceding aspects, the second rotation is comprised between 46° and 500°, particularly comprised between 200° and 350°, more particularly comprised between 280° and 300°.

In a 23rd aspect according to any one of the preceding aspects, the second rotation of the winding body (11) autonomously determines the advancement of the discrete sheet (1b) and its complete wounding around the winding body (11).

In a 24th aspect according to any one of the preceding aspects, the step of thrusting the web or discrete sheet (1a, 1b) towards the winding body (11) is only performed during the first rotation of the winding body (11).

In a 25th aspect according to any one of the preceding aspects, the step of thrusting the web or discrete sheet (1a, 1b) towards the winding body (11) is prior the second rotation of the winding body (11), particularly wherein said thrusting step is not performed during the second rotation of the winding body (11).

In a 26th aspect according to any one of the preceding aspects, the step of inserting at least part of the end portion (2) into the groove (13) of the winding body (11) defines a constrain, particularly a rotational constrain, between the winding body (11) and end portion (2), said constrain causing the web or discrete sheet (1a, 1b) to be pulled during the step of rotating the winding body (11) in order to enable the winding, particularly during the first and/or second rotations of the winding body (11).

In a 27th aspect according to any one of the preceding aspects, the providing step provides to supply the web (1a) from a supply station (30) along an unwinding direction (UD), the web (1a) being unwound from a reel (31) rotatively movable around an axis of rotation (B) or the web (1a) being folded into overlapping layers to define a stack of continuous sheets.

In a 28th aspect according to the preceding aspect, the unwinding direction (UD) of the web is orthogonal to the axis (A) of the winding body (11) and optionally, if the web (1a) is unwound from a reel (31), the axis of rotation (B) of this latter is parallel to the axis (A) of the winding body (11).

In a 29th aspect according to any one of the preceding aspects, wherein the method comprises a step of cutting the web (1a), at a cutting station (40), for defining the discrete sheet (1b), said cutting step being following the step of thrusting the web (1a).

In a 30th aspect according to the preceding aspect, said cutting step defines a cut of the web (1a) orthogonal to the unwinding direction (UD).

In a 31st aspect according to any one of the two preceding aspects, said cutting step is following the first rotation of the winding body (11) and prior the second rotation of the winding body (11).

In a 32nd aspect according to any one of the preceding aspects, the step of thrusting the web or discrete sheet (1a, 1b) comprises a step of actuating at least one pusher (15), said pusher comprising at least one of one or more driving rolls (15a) and one or more movable plates.

In a 33rd aspect according to any one of the preceding aspects, the step of thrusting the web (1a) towards the winding body (11) provides a step of rotatively actuating at least one pulling roll (15a) arranged in contact with the web (1a), particularly a step of rotatively actuating a pair of reciprocally counter-rotating driving rolls (15a).

In a 34th aspect according to any one of the preceding aspects, the mutual overlapping portion (4) has a substantially rectangular shape extending for a length equal to the distance between the first and second free edges (51, 52) of the straw (50).

In a 35th aspect according to any one of the preceding aspects, the mutual overlapping portion (4) extends orthogonally to the first and second free edges (51, 52) of the straw (50).

In a 36th aspect according to any one of the preceding aspects, the mutual overlapping portion covers an angular extension of the straw (50) comprised between 20° and 180°, particularly comprised between 70° and 135°, particularly comprised between 110° and 130°.

In a 37th aspect according to any one of the preceding aspects, the lateral surface (12) of the winding body (11) has a polygonal shape or comprises a first surface (12a) having a semi-cylindrical shape, and a second surface (12b) substantially flat or concave, the second surface (12b) having alternatively a convex shape having a curve radius greater than a curve radius of the first surface.

In a 38th aspect according to any one of the preceding aspects, the first surface (12a) of the lateral surface (12) has a first distance D1, particularly a first radius from the axis (A) of the winding body (11), the second surface (12b) of the lateral surface (12) of the winding body (11) having a second distance D2 from the same axis (A), the first distance D1 being greater than the second distance D2.

In a 39th aspect according to any one of the preceding aspects, the second surface (12b) of the winding body extends parallel to the axis (A) and optionally has a rectangular shape.

In a 40th aspect according to any one of the preceding aspects, said second surface (12b) extends for the overall length of the winding body (11).

In a 41st aspect according to any one of the preceding aspects, the winding body (11) has a cross-section, according to a plane orthogonal to the axis (A), comprising a first outline (11a) preferably semi-circular, defining a first radius or first distance D1 from the axis (A), and a second outline (11b), particularly rectilinear, concave, or convex defining a second distance D2 from the axis (A), the first distance D1 being greater than the second distance D2.

In a 42nd aspect according to any one of the preceding aspects, the cross-section of the winding body (11), according to a plane orthogonal to the axis (A), further comprises an outline of the groove (13) extending towards the axis (A), particularly the outline of said groove (13) defines a seat having a width lower than the depth.

In a 43rd aspect according to any one of the preceding aspects, the straw (50) has a cylindrical shape defining an inner circumference IC, the sum of a longitudinal extension of said first and second outlines (11a, 11b) defining a dimension L lower than said inner circumference IC of the straw (50), particularly wherein 0.5*IC<L<0.98*IC, more particularly wherein 0.7*IC<L<0.95*IC.

In a 44th aspect according to any one of the preceding aspects, the step of constraining the end portion (2) to the tail portion (3) comprises at least the steps of:
putting in contact to each other the end portion (2) and the tail portion (3);
heat-sealing or gluing to each other said end and tail portions (2, 3).

In a 45th aspect according to the preceding aspect, said heat-sealing step comprising the steps of:
interposing at least part of the mutual overlapping portion (4) between the winding body (11) and a heat-sealing element (21);
applying a thrust by the heat-sealing element (21) on the mutual overlapping portion (4) allowing to seal the end portion (2) to the tail portion (3), optionally in order to enable to seal the end portion to the tail portion.

In a 46th aspect according to the preceding aspect, the heat element (21) is a heat-sealing bar, the constraining step comprising a step of moving said heat-sealing bar between: a distal position wherein the winding body (11) and heat-sealing bar are distanced from each other; and an approached position wherein the winding body (11) and heat-sealing bar are close to each other, wherein the heat-sealing bar applies a thrust on the mutual coupling portion (4) at least when this latter is interposed between the heat-sealing bar and winding body (11).

In a 47th aspect according to the preceding aspect, in said approached position, the mutual coupling portion (4) is interposed between the heat-sealing bar and the second surface (12b) of the lateral surface (12) of the winding body (11).

In a 48th aspect according to any one of the preceding aspects, the second surface (12b) of the lateral surface (12) of the winding body (11) is arranged, at the end of the second rotation of the winding body, at the heat-sealing bar.

In a 49th aspect according to any one of the preceding aspects, the constraining step is following a complete winding of the sheet around the winding body (11), particularly the constraining step being after the second rotation of the winding body (11).

In a 50th aspect according to any one of the preceding aspects, the step of cutting the web (1a) defines a discrete sheet (1b) separated from the continuous web, the first rotation of the winding body (11) determining a partial winding of the web (1a) around the winding body (11), the second rotation determining a complete winding of the discrete sheet (1b) around the winding body (11) for defining the cylindrical body (5).

In a 51st aspect according to any one of the preceding aspect, the method comprises a step of ejecting the straw (50) following the constraining step, said ejecting step providing to move the straw (50) along the axis (A) of the winding body (11).

In a 52nd aspect according to any one of the preceding aspects, said ejecting step provides to move the straw (50) along the axis (A) of the winding body (11) between: a first position wherein the straw (50) surrounds the winding body (11); and a second position wherein at least part of the straw (50) exceeds beyond the extension in length of the winding body (11), the straw (50) emerging outside a support structure (60), optionally a transparent support structure (60), defining an inner volume, particularly containing any one of the elements introduced in any one of the preceding claims.

In a 53rd aspect according to any one of the preceding aspects, the step of ejecting the straw (50) comprises moving said straw (50), optionally by means of a sleeve and/or by a gas flow, optionally air, along a direction substantially parallel to the axis (A) of the winding body (11).

In a 54th aspect according to any one of the preceding aspects, the step of ejecting the straw (50) provides to actuate an ejection wheel (113) having an axis of rotation (R) substantially orthogonal to the axis (A) of the winding body (11), said ejection wheel (113) being further movable with respect to the winding body (11) between a distal position and an approached position.

In a 55th aspect according to any one of preceding aspect, said ejecting step comprises the steps of: moving the ejection wheel (113) from the distal position to the approached position, the sheet material of the straw (50) being interposed in contact between said ejection wheel (113) and winding body (11); putting in rotation said ejection wheel (113) around its axis of rotation (R) for moving the straw (50) along the axis (A) of the winding body (11) and for determining the ejection; optionally moving the ejection wheel (113) from the approached position to the distal position.

In a 56th aspect according to any one of the preceding aspects, the ejecting step comprises the step of positioning the second surface (12b) of the lateral surface (12) of the winding body (11) at, particularly in front of, the ejection wheel (113), so that, when the ejection wheel (113) is arranged in the approached position, the sheet material of the straw (50) is interposed in contact between the second surface (12b) of the lateral surface (12) of the winding body (11) and the ejection wheel (113).

In a 57th aspect according to any one of the preceding aspects, the winding body (11) has a first radial size, the method further comprising:
predisposing an auxiliary winding body (11′) extending along an axis (A′) and having a second radial size, the first radial size being different from, particularly greater than, the second radial size allowing to define straws (50) having different radial sizes, optionally different diameters;

the method comprising the step of selectively guiding the web (1a) or the discrete sheet (1b) towards the winding body (11) or towards the auxiliary winding body (11′).

In a 58th aspect according to the preceding aspect, the method comprises the step of completely winding the web (1a) or the discrete sheet (1b) around the body (11) or the auxiliary winding body (11′).

In a 59th aspect according to any one of the preceding aspects, the second surface (12b) extends angularly with respect to the axis (A) of the winding body (11) of an amount comprised between 10° and 100°, particularly comprised between 20° and 80°, more particularly comprised between 30° and 60°.

In a 60th aspect according to any one of the preceding aspects, the second surface (12b) extends along a direction substantially rectilinear and parallel to the axis (A).

In a 61st aspect according to any one of the preceding aspects, said second surface (12b) extends across the entire length of the winding body (11) useful to wind the web or the discrete sheet (1a, 1b).

In a 62nd aspect according to any one of the preceding aspects, the second surface (12b) has a flat or concave shape, the second surface (12b) having, alternatively, a convex shape having particularly a curve radius greater than a curve radius of the first surface (12a).

In a 63rd aspect according to any one of the preceding aspects, the second surface (12b) has a substantially rectangular shape extending along the axis (A) between a first and a second end portion, and in width between a third and a fourth end portion connecting the first surface (12a), particularly wherein the third and fourth end portions are parallel to each other, particularly wherein the third and fourth end portions are distanced by a dimension comprised between 2 mm and 10 mm, particularly comprised between 3 mm and 8 mm.

In a 64th aspect according to any one of the preceding aspects, the winding body (11) has a cross-section, according to a plane orthogonal to the axis (A), having a substantially polygonal shape.

In a 65th aspect according to any one of the preceding aspects, the first surface (12a) has a substantially semi-cylindrical shape having a first radius, the first distance D1 of the first surface (12a) with respect to the axis (A) being equal to said first radius.

In a 66th aspect according to the preceding aspect, wherein 0.4*D1<D2<0.95D1, particularly 0.7*D1<D2<0.9*D 1.

In a 67th aspect according to any one of the preceding aspects, the winding body (11) has a cross-section, with respect to a plane orthogonal to the axis (A), comprising a first outline (11a) having the first radius or first distance D1 from the axis (A), and a second outline (11b) defining the second distance D2 from the axis (A), the first distance D1 being greater than the second distance D2, particularly wherein the first outline (11a) is defined by a cross-section view of the first surface (12a) and the second outline (12b) is defined by a cross-section view of the second surface (12b).

In a 68th aspect according to any one of the preceding aspects, the second outline (11b) has a length comprised between 2 mm and 10 mm, particularly comprised between 3 mm and 8 mm.

In a 69th aspect according to any one of the preceding aspects, the winding body (11) comprises a groove (13) extending, particularly extending completely, along the axis (A), said groove (13) being made on a lateral surface (12) of the winding body (11) for defining a seat.

In a 70th aspect according to the preceding aspect, said seat having a width value suitable to receive the entering sheet material of the straw, particularly said width being comprised between 0.1 mm and 2 mm, particularly between 0.4 mm and 1 mm.

In a 71st aspect according to any one of the preceding aspects, the groove (13) has a cross-section view, according to a plane orthogonal to the axis (A) of the winding body (11), having a substantially polygonal or C shape.

In a 72nd aspect according to any one of the preceding aspects, the groove (13) has a depth, measured from the lateral surface (12) of the winding body (11) to a bottom portion of the groove (13) itself, comprised between 1 mm and 8 mm, particularly comprised between 2 mm and 7 mm, particularly said depth of the groove (13) being lower than the radius of a maximum radial size of the winding body (11).

In a 73rd aspect according to any one of the preceding aspects, the apparatus comprises a guide (14) adjacent the winding body (11) and configured to guide the web (1a) or the discrete sheet (1b) around the winding body (11) allowing it to be wound, the discrete sheet or web being configured to move, at least during an operative condition of the apparatus (100), between the guide (14) and the winding body (11).

In a 74th aspect according to the preceding aspect, said guide (14) comprises an abutment portion extending at least partially parallel to the axis (A) of the winding body and having a concave curved surface facing a lateral surface (12) of the winding body (11).

In a 75th aspect according to any one of the preceding aspects, the apparatus comprises at least one motor (19) connected to the winding body (11) and to the control unit (70) and configured to put in rotation said winding body (11) around its axis (A) for pulling the web or the discrete sheet (1a, 1b) and enabling it to be wound.

In a 76th aspect according to any one of the preceding aspects, the constraining station (20) comprises a heat-sealing element (21) configured to contact at least part of the mutual overlapping portion (4) interposed between said heat-sealing element (21) and the winding body (11).

In a 77th aspect according to any one of the preceding aspects, the heat-sealing element (21) is: movable along a direction parallel to the winding body (11), optionally the constraining station (20) comprising an actuator (29) connected to the heat-sealing element (21) and configured to command the movement at least during the step of constraining the tail portion (3) to the end portion (2); or movable along a direction transversal, particularly orthogonal, to the winding body (11).

In a 78th aspect according to any one of the preceding aspects, the constraining station (20) comprises an actuator (29) connected to the heat-sealing element (21) and configured to command its movement between:

a distal position wherein the winding body (11) and the heat-sealing element (21) are distanced from each other; and an approached position wherein the winding body (11) and the heat-sealing element (21) are close to each other.

In a 79th aspect according to any one of the preceding aspects, the heat-sealing element (21), at least during an operative condition of the apparatus, applies a thrust to the mutual coupling portion (4) when this latter is interposed between the heat-sealing element (21) and the winding body (11).

In an 80th aspect according to any one of the preceding aspects, said heat-sealing element (21) is a heat-sealing bar extending along the axis (A) of the winding body (11) and facing this latter.

In an 81st aspect according to any one of the preceding aspects, in said approached position, the mutual coupling portion (4) is interposed between the heat-sealing bar and the second surface (12b) of the lateral surface (12) of the winding body (11).

In an 82nd aspect according to any one of the preceding aspect, the constraining step is following a complete winding of the sheet around the winding body (11), particularly the constraining step being following the second rotation of the winding body (11).

In an 83rd aspect according to any one of the preceding aspects, the apparatus comprises at least one cutting station (40) comprising at least one cutting tool selected between a rotating or translating blade, said cutting station (40) being configured to define a cut on at least one portion of the web (1a), said cut being transversal, optionally orthogonal to, the unwinding direction (UD) of the web (1a), the cutting station (40) comprising at least one actuator (49) configured to move the cutting tool along a direction substantially parallel to the axis (A) of the winding body (11), optionally said cut being made at the tail portion (3).

In an 84th aspect according to any one of the preceding aspects, the at least one pusher (15) comprises at least one movable plate or at least one pulling roll extending along and movable around its axis of rotation (C). In an 85th aspect according to any one of the preceding aspects, said pusher (15) comprises a first and a second driving roll (15′, 15″) substantially parallel to each other and configured to contact the web or discrete sheet (1a, 1b), particularly the web or discrete sheet (1a, 1b) being pressure-interposed between the first and second driving rolls (15′, 15″).

In an 86th aspect according to the preceding aspect, a plane intersecting the axis of rotation of the first and second driving rolls (15′, 15″) is substantially orthogonal to the unwinding direction (UD) of the web or discrete sheet (1a, 1b).

In an 87th aspect according to any one of the preceding aspects, the pusher (15), particularly the at least one pulling roll, is interposed between the cutting station (40) and supply station (30).

In an 88th aspect according to any one of the preceding aspects, the winding body (11) of the forming station (10) has a first radial size, optionally a first diameter, the forming station (10) further comprising an auxiliary winding body (11′) configured to receive by winding the web or discrete sheet (1a, 1b), wherein the auxiliary winding body (11′) extends along an axis (A′) and has a second radial size, optionally a second diameter, different from the first radial size, optionally from the first diameter, for defining straws (50) having different radial sizes.

In an 89th aspect according to any one of the preceding aspects, the apparatus (100) comprises a deflector movable at least between: a first position, wherein said deflector is configured to guide the web or discrete sheet (1a, 1b) towards the winding body (11); and a second position, wherein said deflector is configured to guide the web or discrete sheet (1a, 1b) towards the auxiliary winding body (11′).

In a 90th aspect according to any one of the preceding aspects, wherein the support structure (60) defines a housing receiving at least the supply station (30), the forming station (10) and the constraining station (20); the support structure (60) comprising at least one lateral wall (61), a base wall and a top wall connected to the lateral wall for limiting an access of a user to the substantially closed inner volume, particularly wherein a wall is at least partially transparent allowing, from the outside of the support structure (60), to see the inner volume.

### DETAILED DESCRIPTION

In the following, a method and apparatus for manufacturing straws according to different embodiments of the same invention will be described.

Apparatus

In the following, an apparatus 100 for manufacturing straws 50 according to the present description and attached claims will be described. The apparatus consists of a small tabletop machine for manufacturing paper straws, wherein the straws are individually manufactured and on direct demand from the user/retailer.

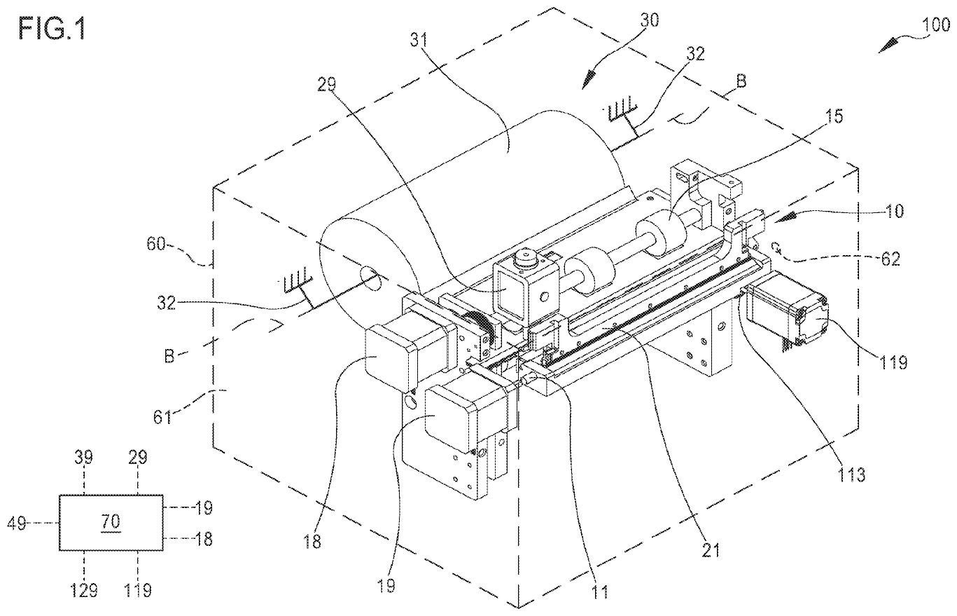

The apparatus 100, schematically shown in FIG. 1, comprises a support structure 60 defining an inner volume adapted to receive the elements and stations described in the following. The support structure 60 comprises at least one lateral wall 61, for example formed by four flat panels joined to each other, and a top wall connected to the lateral wall for limiting an access of a user into the inner volume. The support structure 60 can comprise a base wall connected to the lateral wall for defining a substantially closed inner volume. More particularly, the support structure 60 comprises an opening 62 arranged at a lateral wall 61 or top wall and configured to enable to eject a straw 50, so that a user can withdraw it. In a preferred embodiment, the support structure 60 is at least partially made of a transparent material enabling a user to see the inner volume from the outside. Particularly, at least one lateral wall 61 of the support structure 60 is at least partially made of a transparent material, for example glass or plastics. Alternatively, the lateral walls can be made of non-transparent material, for example of metal, plastic, or composite material. Preferably, the structure will be compact so that can be placed on any table of a bar or similar retailing business and has a reduced size, for example comprised in one or more of the following dimensions:

a width comprised between 10 cm and 100 cm; and/or

a length or depth comprised between 10 cm and 100 cm; and/or

a height comprised between 10 cm and 100 cm.

The apparatus 100 comprises a supply station 30. shown in FIGS. from 1 to 4, configured to receive or support a web 1a or discrete sheets 1b of paper material. Other details about the characteristics of the web 1a or discrete sheets 1b are given in the following section regarding a manufacturing method.

The supply station 30 can comprise a support 32 configured to support a reel 31 of the web 1a and to enable a rotation around an axis of rotation B. The reel 31, rotatively movable around the axis B, is configured to unwind consecutive portions of the web 1a along an unwinding direction UD. According to the first embodiment, the support 32 is configured to receive a reel 31 having the axis of rotation B parallel to a winding body 11 apt to receive by winding the paper material. Alternatively, according to an embodiment not shown in the attached figures, the support 32 is configured to receive a reel 31 having the axis of rotation B orthogonal to the winding body 11.

The supply station 30 can comprise a motor 39 placed at the support 32 and, at least during an operative condition of the apparatus 100. connected to the reel 31: therefore the motor 39 is configured to put in rotation the reel 31 in order to unwind consecutive portions of the web 1a. The motor 39 of the supply station is connected to, and controlled by, a control unit 70 also placed inside the support structure 60. The control unit is configured to cause the reel 31 to rotate or stop and to vary the rotation speed thereof. Alternatively, the supply station 30 comprises an idle support 32, without any motor: in this case, the support 32 can optionally comprise a brake configured to, at least during an operative condition of the apparatus, prevent or limit the rotation of the reel 31, in order to keep tight the unwound portion of the web 1a. The supply station 30 can comprise, as an alternative to the support 32, a storage volume (not shown in the attached figures) configured to receive a stack of discrete sheets 1b or a web folded as reciprocally overlapped laps in order to define a stack of continuous sheets. The web 1a and sheet 1b extend longitudinally between an end portion 2 and tail portion 3.

The apparatus 100 further comprises a forming station 10 configured to cause the web 1a or sheet 1b of paper material to be wound in order to define the straw 50. The forming station 10 comprises at least one rotatively movable winding body 11 extending along an axis A and having a first radial size around which the sheet material is configured to be wound for defining a cylindrical body 5 of paper material, wherein the end portion 2 and tail portion 3 face each other in order to define a mutual overlapping portion 4. Particularly, during the winding step, the end portion 2 and tail portion 3 are substantially parallel to each other and parallel to the axis A of the winding body 11. The steps of winding and manufacturing the straw 50 are specifically described in the section regarding the method.

The winding body 11 can feature a substantially cylindrical shape: alternatively, a cross-section according to a plane orthogonal to the axis A of the winding body can have a circular or polygonal shape or a combination thereof. Obviously, an at least partially cylindrical or elliptical size, or any curved outer surface, is preferable for defining respectively a circular section of the wall of the straw 50. Moreover, it is observed that the winding body may take such size by using corresponding sectors whose outer surface defines an envelope of the described geometry showing at the same time surface discontinuities (voids); for example, a plurality of circular sectors reciprocally separated by respective radial grooves.

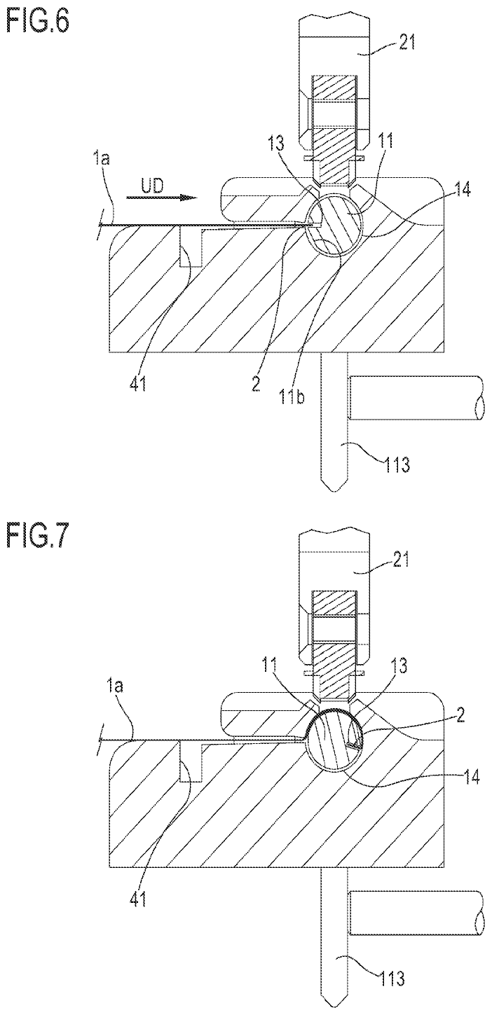

The winding body 11, particularly shown in the perspective view of FIG. 5 and in the corresponding cross-section view of FIG. 5A according to a plane orthogonal to the axis A, has a lateral surface 12 comprising at least one first surface 12a, and at least one second surface 12b both extending along the axis A of the winding body 11, wherein the first surface 12a of the lateral surface 12 has a first distance D1 from the axis A of the winding body 11, while the second surface 12b of the lateral surface 12 of the winding body 11 has a second distance D2 from the same axis A: as clearly shown in the attached figures, the first distance D1 is greater than the second distance D2. More particularly, the first distance D1 and second distance D2 meet the formula 0.4*D1<D2<0.95*D1, more particularly the formula 0.7*D1<D2<0.9*D1.

Analogously, according to the cross-section view of FIG. 5A, the first and second surfaces 12a, 12b respectively define a first and second outlines 11a, 11b, analogously having respective distances D1 and D2 from the axis A of the winding body 11.

According to the embodiment shown in FIGS. from 5 to 10. the first surface 12a and first outline 11a feature a semi-circular shape having a radius equal to the first distance D1 from the axis A of the winding body 11, while the second surface 12b and second outline 11b define a flat portion of the winding body 11 having a substantially flat shape defining the second distance D2 from the same axis A.

Particularly, the second surface 12b has a substantially rectangular flat shape longitudinally extending along the axis A between a first and second end portions, and in width between a third and fourth end portions in connection with the first surface 12a, wherein the third and fourth end portions are parallel to each other and distanced by a dimension D3 (see FIG. 5) comprised between 2 mm and 10 mm, particularly comprised between 3 mm and 8 mm. In other words, such distance D3 defines the length of the second outline 11b of the cross-section view shown in FIG. 5A. Alternatively, the second surface 12b and second outline 11b can feature a concave shape (not shown in the attached figures), in order to define a recess of the lateral surface 12, or a convex shape, particularly a convex semi-circular shape. If the first surface 12a has a semi-circular shape and the second surface 12b has also a convex semi-circular shape, the curve radius of the second surface 12b is greater than the curve radius of the first surface 12a.

In an alternative embodiment not shown in the attached figures, the lateral surface 12 of the winding body can feature a substantially polygonal shape, for example pentagonal, hexagonal, octagonal shape, etcetera. In this case, according to a cross-section view according to a plane orthogonal to the axis A, the vertexes of the polygonal lateral wall 12 define the first surface 12a and the first outline 11a, while the sides of the lateral surface 12 define the second surface 12b and second outline 11b. Indeed, in case of the polygonal cross-section, the vertexes feature a distance from the axis A greater than a same distance of the single sides. According to such embodiment, it is observed that such vertexes can be advantageously radiused in order to define curved surfaces making easy to wind the sheet material and for preventing it from being damaged.

Generally, the second surface 12b extends along a substantially rectilinear direction parallel to the axis A: particularly, the second surface 12b extends for all the length of the winding body 11 useful to wind the web or discrete sheet 1a, 1b. Analogously, also the first surface 12a extends along a substantially rectilinear direction parallel to the axis A for all the length of the winding body 11.

Preferably, the second surface 12b and second outline 11b extend angularly with respect to the axis A of the winding body 11 an amount comprised between 10° and 100°, particularly comprised between 20° and 80°: more particularly, according to the embodiment shown in FIG. 5, such angular amount is comprised between 30° and 60°.

The winding body 11 has a maximum radial size, particularly a maximum diameter, defined by the first surface 12a and comprised between 5 mm and 25 mm, particularly comprised between 6 and 12 mm. Such maximum radial size of the winding body substantially defines the inner diameter of the straw 50.

It is also observed that, in case of a straw 50 having a substantially cylindrical shape defining an inner circumference IC, the sum of a longitudinal extension of the first and second outlines 11a, 11b defines a dimension L lower than the inner circumference IC of the straw 50, particularly wherein 0.5*IC<L<0.98*IC, more particularly wherein 0.7*IC<L<0.95*IC. In other words, the winding body 11 has a shape so that, once the straw 50 is made and wraps the winding body 11, there is at least one gap between the inner surface of the straw and lateral surface 12 of the winding body: particularly, such gap is present between the second surface 12b of the winding body 11 and the inner lateral surface of the straw 50. Such gap enables to prevent the straw 50 from jamming on the winding body 11 during and after the winding step, in order to make easier its following ejection. Preferably, the winding body has a length comprised between 5 cm and 50 cm, particularly comprised between 8 cm and 25 cm. Further, the winding body 11 can feature, at a lateral surface thereof, an outer layer of a gummy material adapted to increase the adhesion to the web or sheet 1a, 1b and enabling to pull it during the step of rotating the winding body 11 itself. Moreover, the winding body 11 comprises a groove 13, shown in FIG. 5 and in the cross-sections shown in FIGS. from 5A to 10, made in the lateral surface 12 of the winding body 11 for defining a seat completely extending along the axis A of the winding body 11. The groove 13 extends along a substantially rectilinear direction parallel to the axis A and has a shape, according to a cross-section view according to a plane orthogonal to the axis A of the winding body 11, having a substantially polygonal or C open outline. The groove 13 has a depth, measured from the lateral surface 12 of the winding body 11 to a bottom portion 13a of the groove 13 itself, comprised between 1 mm and 8 mm, particularly comprised between 2 mm and 7 mm: more particularly such depth of the groove 13 is lower than a radius of a radial maximum size of the winding body 11. The groove 13 radially extends in depth towards the axis A of the winding body A. Moreover, the groove 13 has a width value defined as the distance between a pair of lateral walls 13b′ and 13b″ of the groove 13 extending from the lateral surface 12 to the bottom portion 13a, comprised between 0.1 mm and 2 mm, particularly between 0.4 mm and 1 mm in order to enable to insert part of an end portion of the web 1a or discrete sheet 1b. The apparatus 100 can comprise, besides the winding body 11, an auxiliary winding body 11′, extending along an axis A′ and having a second radial size different from the first radial size of the winding body 11. The auxiliary winding body 11′ is configured to receive by winding the web 1a or discrete sheet 1b for defining a cylindrical body 5 and consequently the straw 50 of paper material. A straw 50, made by winding around the winding body 11, has a radial size, more particularly a diameter, different from the one of a straw made by winding around the auxiliary winding body 11′.

Therefore, the apparatus comprises a deflector movable between a first position, wherein the deflector is configured to guide the web or discrete sheet towards the winding body 11, and a second position, wherein is configured to guide the web or discrete sheet towards the auxiliary winding body 11′.

The apparatus 100 can comprise a motor 19 connected to the winding body 11 and configured to put in rotation the winding body 11 around its axis A for pulling the web or discrete sheet 1a, 1b and enabling the winding. The motor 19 of the winding body 11 is connected and controlled by the control unit 70. Moreover, the forming station 10 can comprise a guide 14 adjacent the winding body 11 and configured to guide the web 1a or discrete sheet 1b around the winding body 11 enabling the winding. The discrete sheet or web are therefore configured to move, at least during an operative condition of the apparatus 100, between the guide 14 and winding body 11. The guide 14 comprises, as shown in the cross-section of FIG. 6, a stationary abutment portion extending at least partially parallel to the axis A of the winding body and having a concave curved surface facing the outer lateral surface 12 of the winding body 11. Particularly, the guide 14 has a cross-section, according to a plane orthogonal to the axis A, substantially semicircular showing a radial size greater than a radial size of the winding body in order to define a gap between the lateral surface 12 of the winding body 11 and an inner lateral surface of the guide 14. The dimension of such gap is comprised between 0.5 mm and 5 mm, more particularly is comprised between 1 mm and 2 mm. Generally, such gap is configured to enable the movement, during the winding steps, of the paper sheet material around the winding body 11.

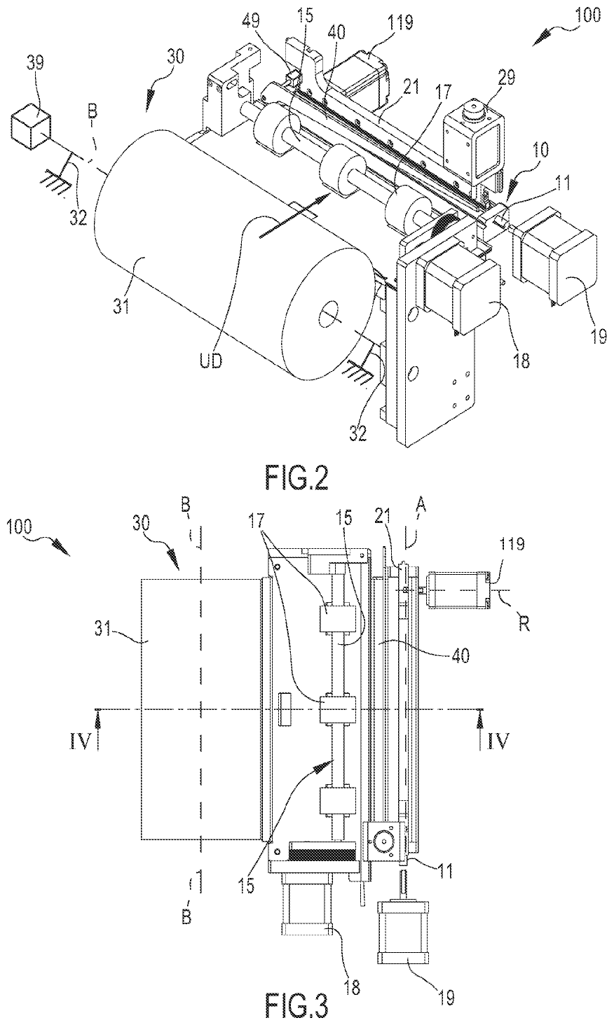

Further, the apparatus comprises a cutting station 40, shown in FIGS. 1 and 2 and by a cross-section in FIGS. from 6 to 10, interposed between the supply station 30 and forming station 10 and comprising at least one cutting tool selected between a rotating or translating blade, and configured to define a cut on at least a portion of the web 1a unwound from the supply station 30. The so defined cut is transversal, more particularly orthogonal, to the unwinding direction UD of the web 1, in order to define the discrete sheet b.

Moreover, the cutting station comprises a recess 41 made on an abutment plane configured to support the web 1a, adapted to receive at the inlet at least part of the blade of the cutting tool. Such recess substantially defines a hollow groove extending transversally to the unwinding direction UD of the web 1a.

Preferably, the cutting station 40 comprises at least one actuator 49 configured to move the cutting tool along a direction parallel to the axis A of the winding body 11. Particularly, the embodiment shown in FIG. 2 comprises a blade rotatively movable around a fulcrum positioned at an end portion of the blade itself. According to an embodiment, the cutting station 40 is arranged at a cutting distance from the winding body 11 lower than or equal to a circumference of the winding body 11, wherein such outer circumference EC is defined by a maximum radial size of the winding body 11. More particularly, such cutting distance CD and such outer circumference EC of the winding body 11 are associated by the relationship 0.25*EC<CD<EC.

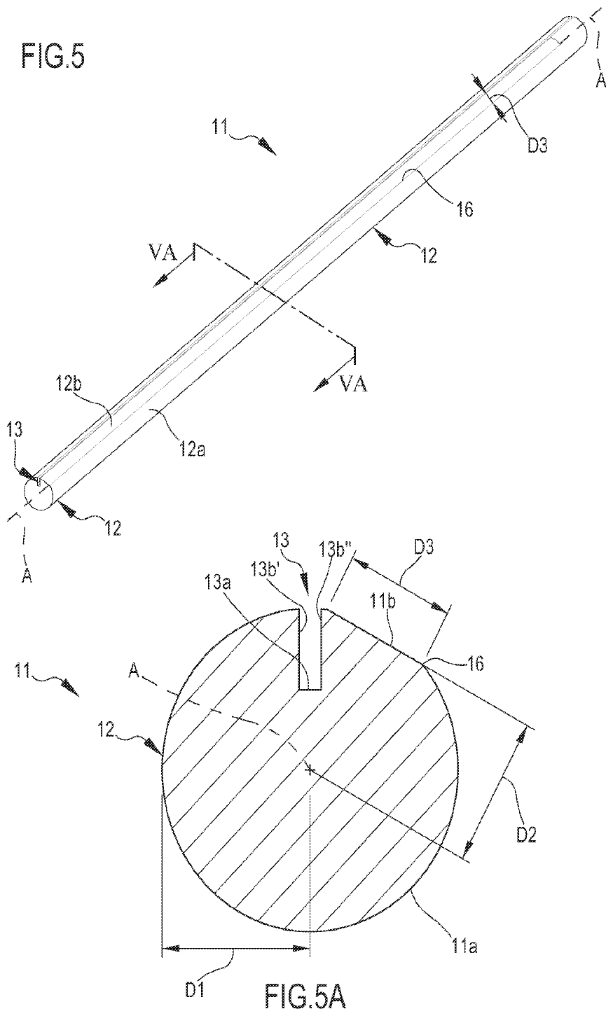

In addition, the apparatus 100 can comprise at least one pusher 15, shown in FIGS. 1, 2 and 3 and by the cross-section of FIG. 4, configured to cause the web 1a or discrete sheet 1b to advance towards the winding body 11 along the unwinding direction UD. According to an embodiment shown in the attached figures, the pusher 15 is interposed between the cutting station 40 and supply station 30, in order to move the web 1a. Alternatively, in an embodiment not shown in the attached figures, the pusher 15 can be interposed between the cutting station 40 and forming station 10. Analogously, an embodiment can provide a pusher 15 interposed between the supply station 30 and cutting station 40 and a further pusher 15 positioned between the cutting station 40 and forming station 10. Generally, the pusher 15 is configured to apply a thrust on the web or discrete sheet towards the winding body 11. In an embodiment, the pusher 15 can comprise one or more plates (not shown in the attached figures) movable along the unwinding direction UD in order to determine the advancement of the web 1a or discrete sheet 1b: for example, a first and second plates can face each other and are movable towards and away from each other, and wherein the paper sheet material is configured to move between the first and second plates. Particularly, the first and second plates are configured to pressure contact the sheet material when are arranged in the approached position, and consequently move along the unwinding direction UD for determining the advancement of the web 1a or sheet material 1b.

In a preferred embodiment shown in the attached figures, the pusher 15 can comprise one or more driving rolls rotatively movable around a respective axis C substantially parallel to the axis A of the winding body 11. Further, the apparatus 100 comprises at least one motor 18 connected to at least one pulling roll and configured to determine the rotation. Additionally, the control unit 70 is connected to the motor 18 of the pulling roll 15 and is configured to command the rotation, stoppage or to vary the rotation speed. The motor 18 can be connected to the pulling roll or rolls by a belt, chain, or by two or more toothed wheels: therefore, a transmission ratio can be defined in order to reduce, or as an alternative to increase, the angular rotation speed of the roll with respect to the one of the motor 18. Further, the pulling roll can comprise, at its lateral surface, an outer layer 17 of gummy material adapted to increase the adhesion to the web or sheet 1a, 1b in order to enable to thrust the latter towards the winding body 11. Specifically, the pusher 15 comprises a first and second driving rolls 15′, 15″ substantially parallel and facing each other so that a plane intersecting the axis of rotation C′, C″ of the first and second driving rolls 15′, 15″ is substantially orthogonal to the support plane of the web 1a, particularly orthogonal to the web 1a or discrete sheet 1b during an operative condition of the apparatus 100. The web 1a or discrete sheet 1b is therefore configured to be arranged in contact between the first and second driving rolls 15′, 15″. The rotation axes C′ and C″ respectively of the first and second driving rolls 15′, 15″ are substantially parallel to the axis A of the winding body 11. Moreover, in an embodiment, only the first or only the second pulling roll 15′, 15″ is a driven roll and is connected to the motor 18, while the other pulling roll is idle. In a further embodiment, both the driving rolls 15′, 15″ are driven rolls and are connected to the motor 18. Moreover, the apparatus comprises a constraining station 20 having at least one heat-sealing element 21 configured to contact, at least in an operative condition of the apparatus, at least part of the mutual overlapping portion 4 interposed between the heat-sealing element 21 and winding body 11. The heat-sealing element 21 can be movable along a direction parallel to the winding body 11, or movable along a direction orthogonal to the winding body 11. The constraining station 20 can comprise an actuator 29 connected to the heat-sealing element 21 and configured to command the movement at least during the step of constraining the tail portion 3 to the end portion 2. Specifically, the heat-sealing element is movable orthogonally to the winding body 11 between a distal position, wherein the winding body 11 and heat-sealing element 21 are distanced from each other, and an approached position, wherein the winding body 11 and heat-sealing element 21 are reciprocally close or in abutment. The heat-sealing element 21, at least in an operative condition of the apparatus, is configured to apply a thrust to the mutual coupling portion 4 when this latter is interposed between the heat-sealing element 21 and winding body 11. In a preferred embodiment, the heat-sealing element 21 is a heat-sealing bar extending along the axis A and adjacent to the winding body 11. More particularly, the heat-sealing bar faces the winding body 11.

In a preferred embodiment, the heat-sealing element 21 is configured to place itself in the approached position when the second surface 12b of the winding body 11 faces the heat-sealing element: in other words, in an operative condition of the apparatus and particularly during the step of heat-sealing the cylindrical body 5, the mutual overlapping portion 4 is pressure-interposed between the heat-sealing element 21 and second surface 12b of the winding body 11. In this case, the second surface 12b and contact portion of the heat-sealing element are counter shaped to each other: for example, the second surface 12b and contact portion of the heat-sealing element can both feature a flat rectangular shape.

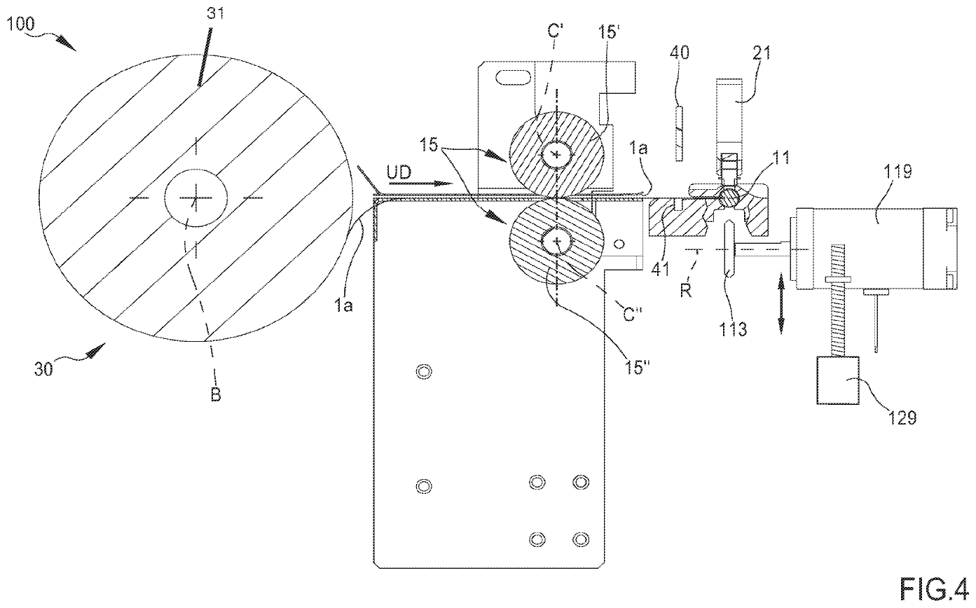

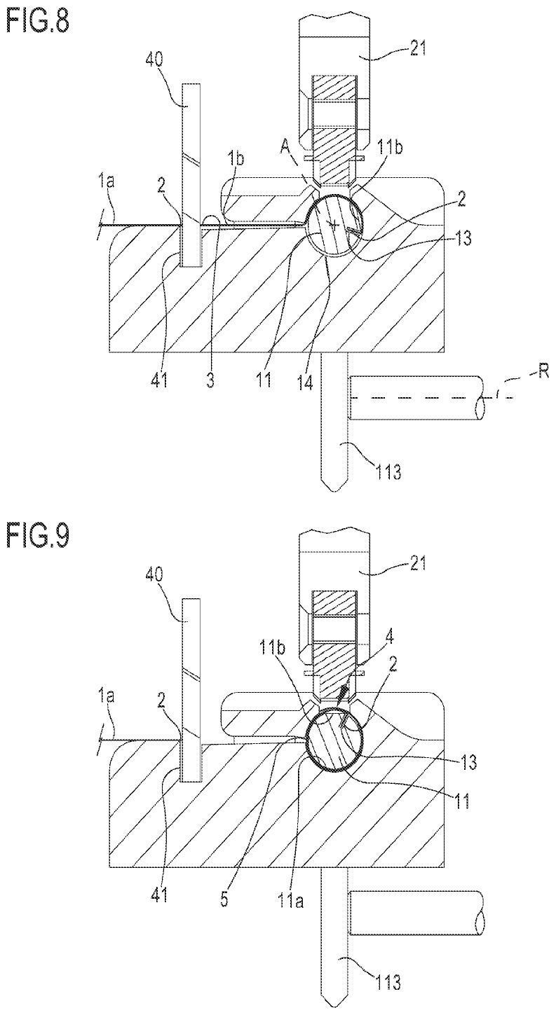

In addition, the apparatus can comprise a user interface configured to enable a user to start a new procedure of manufacturing a new straw 50: for example, the user interface can comprise an actuator, preferably connected to a control unit 70, manually actuatable by the user and configured to enable this latter to activate the apparatus and enable to implement the manufacturing steps for manufacturing at least one straw 50. The actuator comprises one or more buttons, or a touch screen. Therefore, the apparatus 100 is configured to manufacture, at each activation of the actuator, a predefined number of straws 50 comprised between 1 and 5, particularly comprised between 1 and 2 and specifically just one straw per activation having a preselected diameter among the available diameters. After having manufactured the predefined number of straws 50, the apparatus 100 is configured to stop waiting for a new activation of the actuator for manufacturing further straws 50. Additionally, the user interface can be configured to provide, to a user, at least one information representative of one or more diameters of the straw 50. The user interface can be defined by one or more buttons for selecting a respective diameter of the straw 50, a screen or touch screen. Particularly, the buttons, screen or touch screen can comprise an image representative of a diameter of the straw, in order to enable a user to select the desired size. Moreover, the apparatus 100 comprises an ejection station 110 configured to enable to remove the straw 50 from the winding body 11 and to eject it from the support structure 60 so that the same can be taken by the user. Particularly, the ejection station 110 can comprise a sleeve or blower configured to move the straw 50 along the axis A of the winding body and to enable to eject it. The sleeve can be moved by a motor or electric actuator and is configured to contact the straw 50, when this latter is wound around the winding body 11, and move it parallel to the axis A. Alternatively, the blower is configured to generate a gas flow along a direction substantially parallel to the axis A of the winding body 11 in order to cause the straw 50 to be moved and ejected. In a preferred embodiment shown in the attached FIG. 11, the ejection station comprises an ejection wheel 113 rotatively movable around an axis of rotation R substantially orthogonal to the axis A of the winding body 11 (see FIG. 3). A motor 119 is connected to the ejection wheel 113 and control unit 70 for commanding the rotation of the ejection wheel 113.

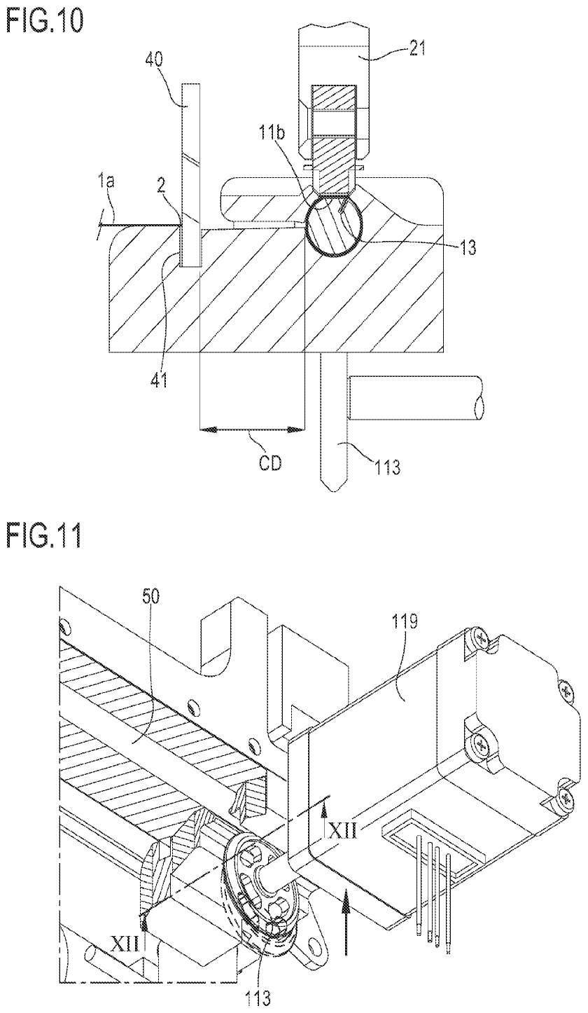

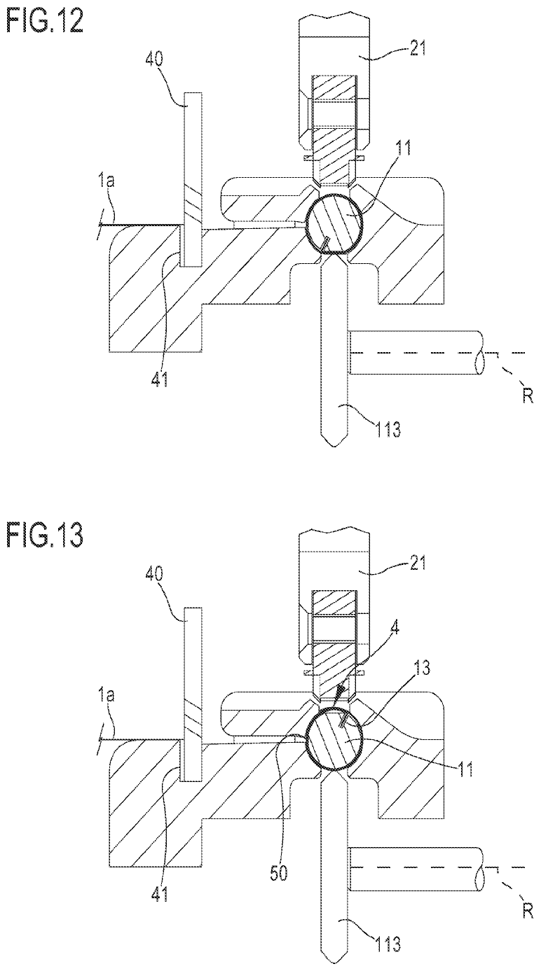

Moreover, the ejection wheel 113 is movable with respect to the winding body 11 between a distal position and an approached one along a direction substantially orthogonal to the axis A of the winding body 11: during a step of ejecting the straw 100, shown in FIGS. 12 and 13, therefore the sheet material of the straw is pressure-interposed between the ejection wheel 113 and winding body 11. More particularly, in the embodiment of FIG. 13, the sheet material of the straw 50 is interposed during the ejecting step between the first surface 12a of the winding body 11 and ejection wheel 113, while in the embodiment of FIG. 12, the sheet material of the straw 50 is interposed during the ejecting step, between the second surface 12b of the winding body 11 and ejection wheel 113. An actuator 129 is connected to the ejection wheel 113 and control unit 70 and is configured to determine its movement from the distal position to the approached one and vice versa. The rotation of the ejection wheel 113 around its axis R, when the wheel is in the approached position, determines the movement of the straw 50 along the axis A of the winding body 11. Moreover, the ejection wheel 111 can feature, at its lateral surface, an outer layer of a gummy material adapted to increase the adhesion to the paper material of the straw 50 and to ensure the movement during the ejection step along the axis A of the winding body.

Particularly, the control unit 70 is configured to sequentially implement the following ejecting steps:
moving the ejection wheel 113 from the distal position to the approached one, wherein the ejection wheel, when is arranged in the approached position, contacts the sheet material of the straw 50 interposed between the ejection wheel 113 and winding body 11;
putting in rotation the ejection wheel 113 around its axis of rotation R for moving the straw 50 along the axis A of the winding body 11 in order to determine the ejection of the support structure 60 through the opening 62. Once the straw is ejected, the control unit 70 is configured to move the ejection wheel 113 from the approached position to the distal one, in order to enable to wind the sheet material for manufacturing a new straw 50.

Generally, the beforehand described control unit 70 is configured to sequentially perform the method steps according to the following description and attached claims.

Method of Manufacturing Straws

The method of manufacturing straws 50 is specifically devised to be applied to a small tabletop machine for repeatedly manufacturing single paper straws on-demand. The method provides to predispose, at the supply station 30, a web or at least one discrete sheet 1a, 1b of paper material, as shown in FIGS. from 1 to 10. The web or discrete sheet 1a, 1b is made of a material adapted to contact food and has in thickness a multilayer structure comprising a first layer of paper material and at least one second layer of plastic material constrained to the first paper layer, consequently making the web or discrete sheet impervious at least to the liquids. The plastic material layer can comprise a thin film of polyethylene applied to just one face (poly-coated paper) or both faces (double poly-coated paper) of the web or discrete sheet. In an embodiment, it is provided to use a heat-sealing paper reel which can be possibly printed with logos or different patterns and colors. The web and discrete sheet extend between an end portion 2 and a tail portion 3, preferably parallel to each other and longitudinally extending. The end and tail portions 2, 3 in turn define respectively an end edge 2a and tail edge 3a: the end and tail portions 2, 3 define a surface portion of the web or discrete sheet, while the end 2a and tail edges 3a define a perimetral line of the sheet or web. The end portion 2 and tail portion 3 are interconnected to each other by a pair of lateral edges 6, opposite to each other with respect to the body of the sheet or web and preferably parallel to each other. In a preferred embodiment, the end edge and tail edge are orthogonal to the lateral edge 6. Consequently, the discrete sheet has a rectangular shape.

The method provides to unwind the continuous web along an unwinding direction UD, as shown in FIGS. 2 4 4: the web 1a can be unwound from a reel or roll 31 (see FIG. 1) rotatively movable around an axis of rotation B, or the web 1a can be alternatively folded as reciprocally overlapped laps in order to define a stack of continuous sheets (this embodiment is not shown in the attached figures). Moreover, the method can provide to supply, along the direction UD, one or more discrete sheets. In order to manufacture the straw 50 in the final shape thereof, the method comprises at least one step of winding the web or discrete sheet 1a, 1b around the winding body 11 which extends along a respective axis A. The winding body 11, placed at a forming station 10, has a partially cylindrical or polygonal radial size extending longitudinally along its axis A, as herein specifically described in the apparatus section.

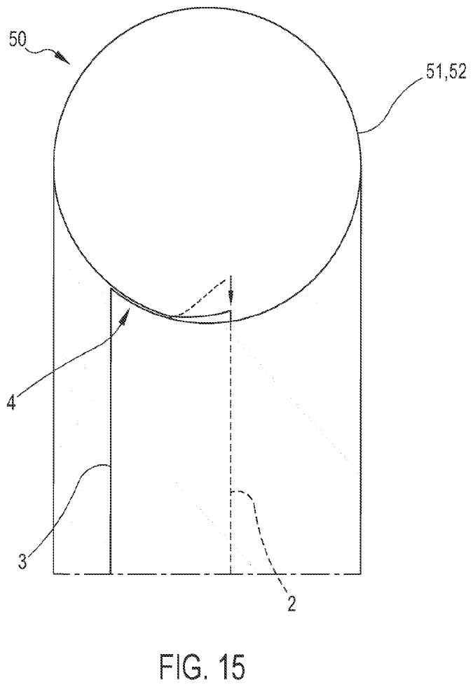

In order to perform the winding step, the method provides to approach the end portion 2 of the web or discrete sheet to the winding body 11 and to insert at least part of the end portion 2 inside the groove 13 made in the winding body 11, as specifically shown in the cross-section of FIG. 6: the groove 13 defines a rotational constrain between the end portion 2 and winding body 11, enabling to drive the web or discrete sheet 1a, 1b during its winding step. During a subsequent step of ejecting the straw, specifically described in the following, the groove 13 further enables the straw to axially move along the winding body 11 enabling to eject it. After approaching the end portion 2 of the web or discrete sheet to the winding body 11, the method provides to rotate the winding body 11 around its axis A for pulling, particularly advancing, the web or discrete film 1a, 1b. The rotation of the winding body 11 is performed by actuating the motor 19, particularly an electric motor 19, connected to the winding body and adapted to put in rotation the winding body 11 around its axis A. Generally, the rotation will be a complete rotation, in other words a rotation of 360°, of the winding body 11 around its axis A, in order to enable to completely wind the web or discrete sheet around the winding body 11. Therefore, an additional rotation is provided for defining a mutual overlapping portion 4 between the reciprocally facing end portion 2 and tail portion 3. The additional rotation can be of an amount required to subsequently enable to easily couple the overlapped layers, advantageously the rotation will be of a further angle preferably lower than 180°, particularly lower than 135° or 100°. The tail and end portions 2, 3 are, in a preferred embodiment, substantially parallel to the axis A of the winding body 11. Consequently, the mutual overlapping portion 4 has a substantially rectangular shape and extends a length equal to the distance between the lateral edges 6 of the sheet or web. More particularly, the mutual overlapping portion covers an angular extension of the straw 50 comprised between 20° and 180°, particularly comprised between 70° and 135°, more particularly comprised between 110° and 130°. According to an embodiment, the winding step provides, after the insertion, to rotate the winding body 11 around the axis A and simultaneously to thrust, by at least one pusher 15, the web or discrete sheet 1a, 1b towards the winding body 11 for determining the winding. In other words, while the winding body 11 drives, by the constrain defined between the groove 13 and end portion 2, the web 1a or discrete sheet 1b during its rotation, the pusher 15 applies a thrust to the web 1a or discrete sheet 1b towards the winding body 11: such thrust contributes, with the driving action determined by the rotation of the winding body 11, to wind the sheet material around the winding body. It is observed, during the rotation of the winding body 11, how a folding edge is formed on the sheet material at a connecting portion 16 interposed between the groove 13 and lateral surface 12 of the winding body 11: the thrust applied by the pusher 15 enables to limit such folding edge, so that, during a following step of ejecting the straw 50, the end portion 2 elastically tends to place itself in contact with an inner surface of the straw, as schematically shown in FIG. 15. This enables to prevent such end portion 2 from projecting inside the straw 50, determining an unattractive appearance and a partial occlusion of the inner channel.

More particularly, the step of rotating the winding body 11 during the winding step comprises a first rotation, shown in FIG. 7, for defining a partial winding of the web or discrete sheet around the winding body 11, wherein such first rotation is comprised between 45° and 315°, particularly comprised between 90° and 270°, still more particularly comprised between 170° and 200°, preferably comprised between 182° and 190°. The thrusting step, performed by the pusher 15, is simultaneous with such first rotation. Specifically, the pusher 15 comprises one or more driving rolls rotatively movable around their rotation axes C and connected to a motor 18, particularly an electric motor 18: the thrusting step therefore provides to rotatively actuate at least one pulling roll in order to determine the advancement of the web 1a. After the first rotation, the method provides a step of cutting the web 1a in a cutting station 40 for defining the discrete sheet 1b, as shown in FIG. 8. The cutting step defines a cut of the web 1a substantially orthogonal to the unwinding direction UD and preferably parallel to the axis A of the winding body 11. Therefore, the discrete sheet 1b, defined by the cut, is interposed between the cutting station 40 and forming station 10. The cutting step is performed for example by moving a cutting tool, e.g., a fixed or rotating blade, along the web portion on which somebody desires to perform a cut, the movement of the cutting tool is preferably performed along a plane substantially parallel to the axis A of the winding body 11 and along a direction orthogonal to the sheet material. If the supply station 30 supplies discrete sheets 1b, the method can be devoid of the cutting step. The rotation of the winding body 11 further comprises a second rotation, shown in FIG. 9, following and in addition to the first rotation, for defining a complete winding of the web or discrete sheet 1a, 1b around the winding body 11: the complete winding defines therefore the cylindrical body 5 and mutual overlapping portion 4. In a preferred embodiment, the second rotation is comprised between 46° and 500°, particularly is comprised between 200° and 350°, more particular comprised between 280° and 300°. Generally, summing the first and second rotations defines an angle comprised between 361° and 540°, particularly comprised between 400° and 500°, preferably comprised between 470° and 480°. The given angles with reference to the first and second rotations are defined from an initial angular position of the winding body in which this latter is configured to receive by insertion, inside the groove 13, the end portion 2 of the sheet material. The initial angular position of the winding body 11, shown in FIG. 6, defines an angle of 0°. According to FIGS. 7 and 9, the first and second rotations are clockwise rotations: however, the method can in the same way provide anticlockwise angular rotations of the winding body. The second rotation of the winding body 11 causes the discrete sheet 1b to be pulled and completely wound around the winding body 11: particularly, the second rotation of the winding body 1 determines autonomously the advancement of the discrete sheet b and its winding around the winding body, without any contribution from the pusher 15. Indeed, the step of thrusting the web 1a towards the winding body 11 is performed only during the first rotation of the winding body 11.

Further, the method comprises a step of constraining, at the constraining station 20, the end portion 2 to the tail portion 3, as shown in FIG. 10, at the mutual overlapping portion 4 in order to define the straw 50. During the constraining step, the end portion 2 and tail portion 3 are put reciprocally in contact and are heat-sealed or glued to each other. More particularly, the heat-sealing step is performed by interposing at least part of the mutual overlapping portion 4 between the winding body 11 and a heat-sealing element 21, and a thrust is applied by the heat-sealing element 21 to the mutual overlapping portion 4 in order to enable to heat-seal the end portion 2 to the tail portion 3, particularly in order to enable to bond the end portion to the tail portion. According to the present embodiment, the method provides a step of heating the heat-sealing element 21 to a predetermined temperature, so that a contact between the heat-sealing element 21 and mutual overlapping portion 4 of the paper material determines locally the bonding. More particularly, the heat-sealing element 21 locally determines the fusion of the plastic layer of the paper material, and consequently the bonding of the end portion 2 to the tail portion 3. In a preferred embodiment, the heat-sealing element 21 is a heat-sealing bar, placed adjacent the winding body 11 and extending along a direction parallel to the axis A of the winding body 11. The method provides to move the heat-sealing bar between a distal position, wherein the winding body 11 and heat-sealing bar are distanced from each other, and an approached position wherein the winding body 11 and heat-sealing bar are close to each other. The transition movement between the distal position and approached one is preferably orthogonal to the axis A of the winding body 11 and is determined by the activation of an actuator or electric motor 29. In the approached position, the heat-sealing bar applies a thrust to the mutual coupling portion 4 when this latter is interposed between the heat-sealing bar and winding body. In a different embodiment, the heat-sealing element 21 can feature a size lower than the extension of the winding body and can be movable along a direction substantially parallel to the axis A of the winding body 11 when is placed in the approached position, in order to gradually bond the mutual overlapping portion. According to a preferred embodiment shown in FIG. 10, the method provides during the constraining step, to arrange the second surface 12b of the winding body 11 at the heat-sealing bar, so that the mutual overlapping portion 4 is interposed between the heat-sealing bar and second surface 12b of the winding body 11.

As beforehand said, the constraining step can alternatively comprise a step of gluing the end portion 2 to the tail portion 3: therefore, the method comprises placing a predetermined amount of glue on the tail portion or end portion for enabling a reciprocal adhesion.

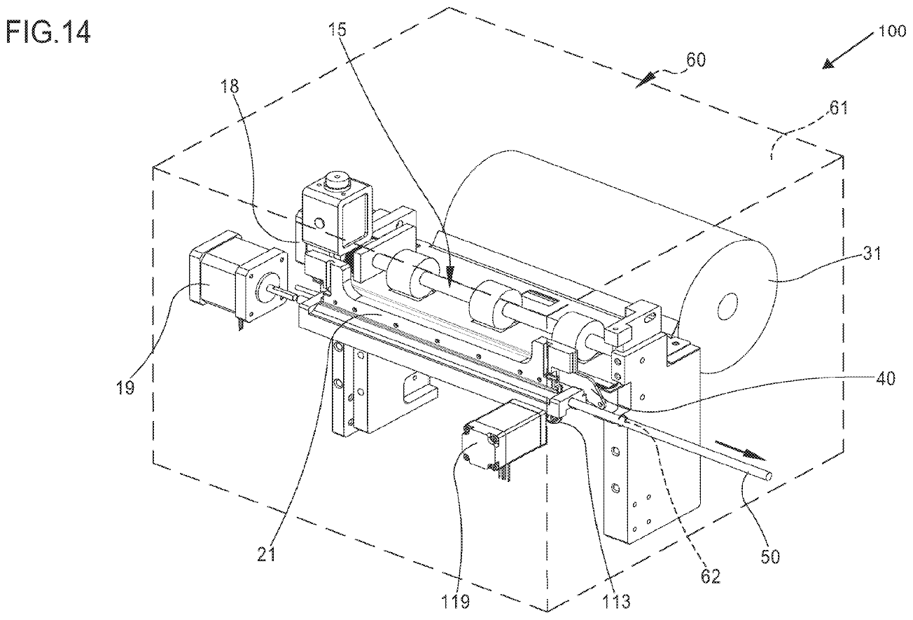

Further, it is provided a step of ejecting the straw 50, after the winding step and constraining step, so that this latter projects from the support structure 60, as shown in FIG. 14. The support structure 60 defines a housing receiving the supply station, forming station, constraining station, ejection station and, according to an optional embodiment, the cutting station. The ejection step enables a user to grip the just manufactured straw and to take it completely out from the opening 62 of the support structure 6 for using it.

The ejection step is performed by moving the straw 50 along the axis A of the winding body 11 between a first position wherein the straw 50 surrounds the winding body 11, and a second position wherein at least part of the straw 50 exceeds beyond the extension in length of the winding body 11, particularly wherein the straw 50 projects from the support structure 60 (see FIG. 14).

Particularly, the method provides to actuate an ejection wheel 113 rotatively movable around an axis of rotation R substantially orthogonal to the axis A of the winding body 11, wherein such ejection wheel 113 is further movable with respect to the winding body 11 between a distal position and an approached one. More particularly, the ejection step comprises the step of moving the ejection wheel 113 from the distal position to the approached one, wherein the sheet material of the straw 50 is interposed in contact between the ejection wheel 113 and winding body 11. Then, the ejection step comprises the step of putting in rotation the ejection wheel 113 around its axis of rotation R for moving the straw 50 along the axis A of the winding body 11 in order to determine the ejection. Once the straw is ejected at least partially, the method provides to take again the ejection wheel from the approached position to the distal one, in order to enable to start a following procedure of manufacturing a new straw.

According to a preferred embodiment, the method provides to position the winding body 11 so that the second surface 12b is placed at the ejection wheel 113: in other words, the method provides, before moving the ejection wheel 113 from the distal position to the approached one, to rotate the winding body and check the position so that the sheet material of the straw is interposed between the second surface 12b of the winding body and ejection wheel 113. Once the second surface 12b is placed at, particularly faces, the ejection wheel 113, the method provides the steps of moving the ejection wheel from the distal position to the approached one and to rotate the wheel around its axis of rotation R for enabling to move the straw along the axis A. It is observed that the ejection wheel 113, during its movement from the distal position to the approached one, applies a thrust to the straw 50 radially directed towards the axis A of the winding body: such thrust determines in turn a deformation of the portion of the straw 50 sheet material interposed between the ejection wheel 113 and second surface 12b, as shown in FIG. 12. Indeed, before the ejection wheel applies a thrust to the straw 50, the straw 50 has a substantially circular shape defining a gap between a portion of its lateral inner surface and the second surface 12b of the winding body 11: such gap, when the ejection wheel 113 is arranged in the approached position, is eliminated causing the same straw to expand and consequently the formation of a free space between the first surface 12a of the winding body 11 and the remaining portion of the inner lateral surface of the straw 50. Such expansion reduces the friction between the straw 50 and winding body 11, making easier to move the straw along the winding body during the step of ejecting the straw itself.

In an alternative embodiment, the movement can optionally comprise a thrusting step, by for example a sleeve, the first or second circular free edges 51, 52 of the straw 50 along a direction substantially parallel to the axis A of the winding body 11. The thrusting step can be performed by activating an actuator or electric motor: particularly, the electric motor provides to put in rotation a threaded bar, which defines a linear movement of the sleeve parallel to the axis A.

Alternatively, the moving step could provide a step of thrusting the straw 50 by a gas flow, for example air, along a direction substantially parallel to the axis A of the winding body 11. The gas flow can be determined by activating a blower or compressor actuated for example by means of an electric motor.

In an alternative arrangement, the method provides the possibility of winding the web or discrete sheet around the winding body 11 extending along an axis A and having a first radial size, or around an auxiliary winding body 11′ extending along an axis A′ and having a second radial size, wherein the first radial size is different from the second radial size in order to define straws 50 having different radial sizes, particularly different diameters. The winding body 11 and the auxiliary winding body 11′ are both placed inside the same support structure 60. The method provides to selectively guide the web 1a or discrete sheet 1b towards the winding body 11, or towards the auxiliary winding body 11′. The simultaneous presence of two (or also more) winding bodies inside the same support structure 60 enables consequently to manufacture straws having different diameters, according to a selection made by a user. The beforehand described manufacturing steps can be performed by one or more control units 70, connected to the supply station, cutting station, constraining station, or ejection station.

1-12. (canceled)

13. Method for manufacturing straws comprising the following steps:
predisposing a web of paper material or a discrete sheet of paper material, said web or discrete sheet extending between an end portion and a tail portion;
predisposing a winding body extending along an axis and rotatively movable around said axis, the winding body comprising a groove extending along the axis and defining a hollow seat;
winding said web or discrete sheet around the winding body for defining a cylindrical body of paper material, wherein the end portion and the tail portion face each other in a mutual overlapping portion;
constraining the end portion to the tail portion at the mutual overlapping portion to define a straw extending between a first and a second circular free edges, said mutual overlapping portion extending between the first and second free edges of the straw along a rectilinear direction, wherein said winding step comprises the following steps:
approaching the end portion of the web or discrete sheet to the winding body;
inserting a part of the end portion in the groove of the winding body;
following the inserting step, rotating the winding body around the axis and simultaneously thrusting said web or discrete sheet towards the winding body for determining the winding.

14. Method according to claim 13, wherein the winding body has a cross-section, according to a plane orthogonal to the axis, comprising a first outline defining a first radius or first distance from the axis and a second outline defining a second distance from the axis, the first distance being greater than the second distance,
and wherein the cross-section, according to the plane orthogonal to the axis, further comprises an outline of the groove extending towards the axis, the outline of said groove defines a seat having a width lower than the depth.

15. Method according to claim 14, wherein the lateral surface of the winding body comprises a first surface having a cylindrical trend, and a second surface flat, or concave, or convex and having a curve radius greater than a curve radius of the first surface,
wherein the first surface of the lateral surface has the first distance from the axis of the winding body, the second surface of the lateral surface of the winding body having the second distance from the same axis, the first distance being greater than the second distance.

16. Method according to claim 15, wherein the second surface extends parallel to the axis and has a rectangular shape, said second surface extending along all the overall length of the winding body.

17. Method according to claim 16, wherein the step of constraining the end portion to the tail portion comprises the sub-steps of:
bringing in contact with each other the end portion and tail portion;
heat-sealing to each other said end and tail portions, said heat-sealing step comprising the steps of:
interposing part of the mutual overlapping portion between the winding body and a heat-sealing element;
applying a thrust by the heat-sealing element to the mutual overlapping portion for allowing to seal the end portion to the tail portion, wherein the heat-sealing element is a heat-sealing bar, the constraining step comprising a step of moving said heat-sealing bar between:
a distal position wherein the winding body and the heat-sealing bar are distanced from each other; and
an approached position wherein the winding body and the heat-sealing bar are flanked between each other, wherein the heat-sealing bar applies a thrust to the mutual coupling portion at least when the mutual coupling portion is interposed between the heat-sealing bar and winding body, and
wherein, in said approached position, the mutual coupling portion is interposed between the heat-sealing bar and the second surface of the lateral surface of the winding body, the second surface of the lateral surface of the winding body being arranged, at the end of the second rotation of the winding body, at the heat-sealing bar.

18. Method according to claim 13, wherein the step of rotating the winding body comprises:
a first rotation for defining a partial winding of the web or discrete sheet around the winding body, said first rotation being lower than 360°, and comprised between 45° and 315°;
a second rotation, following and additional to said first rotation, for defining a single complete winding of the web or discrete sheet around the winding body, said complete winding defining the cylindrical body and mutual overlapping portion; said thrusting step being simultaneous to said first rotation.

19. Method according to claim 18, wherein the second rotation of the winding body autonomously determines the advancement of the discrete sheet and a complete winding thereof around the winding body, and wherein the step of thrusting the web or discrete sheet towards the winding body is only performed during the first rotation of the winding body, the step of thrusting the web or discrete sheet towards the winding body is prior the second rotation of the winding body, and wherein said thrusting step is not performed during the second rotation of the winding body.

20. Method according to claim 18, comprising a step of cutting the web, at a cutting station, for defining the discrete sheet, said cutting step following the step of thrusting web, wherein said cutting step is following the first rotation of the winding body and prior the second rotation of the winding body,
said cutting step defining a cut of the web orthogonal to the unwinding direction.

21. Method according to claim 13, wherein the step of predisposing the web provides to supply the web from a supply station along an unwinding direction, the web being unwound from a reel rotatably movable around an axis of rotation, wherein the unwinding direction of the web is orthogonal to the axis of the winding body and the web has the axis of rotation parallel to axis of the winding body.

22. Method according to claim 13, wherein the step of thrusting the web or discrete sheet comprises a step of driving in rotation a pair of counter-rotating drive rolls placed in contact with the web or discrete sheet.

23. Method according to claim 13, comprising an ejection wheel having an axis of rotation orthogonal to the axis of the winding body, said ejection wheel being further movable with respect to the winding body between a distal position and an approached position, the method comprising a step of ejecting the straw following the constraining step, said ejecting step providing to move the straw along the axis of the winding body between:
a first position wherein the straw surrounds the winding body; and
a second position wherein a portion of the straw exceeds beyond the extension in length of the winding body,
wherein the step of ejecting the straw provides the steps of:
actuating the ejection wheel;
moving the ejection wheel from the distal position to the approached position, the sheet material of the straw being interposed in contact between said ejection wheel and the winding body;
putting in rotation said ejection wheel around its axis of rotation for moving the straw along the axis of the winding body and for determining its ejection;
moving the ejection wheel from the approached position to the distal position.

24. Method according to claim 23, wherein the ejecting step comprises the step of positioning the second surface of the lateral surface of the winding body in front of the ejection wheel, so that when the ejection wheel is arranged in the approached position, the sheet material of the straw results interposed in contact between the second surface of the lateral surface of the winding body and ejection wheel.

25. Method according to claim 13, wherein the winding body has a cross-section, according to a plane orthogonal to the axis, comprising a first outline that is semi-circular, defining a first distance from the axis, and a second outline that is rectilinear, concave or convex, defining a second distance from the axis, the first distance being greater than the second distance,
the straw having a cylindrical shape defining an inner circumference, the sum of a longitudinal extension of said first and second outlines defining a dimension L lower than said inner circumference of the straw, wherein 0.7*IC<L<0.95*IC,
IC being the inner circumference.

26. Method according to claim 13, wherein the step of inserting part of the end portion into the groove of the winding body defines a rotational constrain between the winding body and end portion, said constrain causing the web or discrete sheet to be pulled during the step of rotating the winding body to wind.

27. Method according to claim 13, further comprising:
providing a guide adjacent the winding body and configured to guide the web or the discrete sheet around the winding body allowing it to be wound, said guide comprising an abutment portion extending parallel to the axis of the winding body and having a concave curved surface facing a lateral surface of the winding body,
providing a motor connected to the winding body to put in rotation said winding body around its axis for pulling the web or the discrete sheet and enabling it to be wound, during an operative condition, the discrete sheet or web being moved between the guide and the winding body.

28. Method for manufacturing straws comprising the following steps:
providing a web of paper material or a discrete sheet of paper material, said web or discrete sheet extending between an end portion and a tail portion;
providing a winding body extending along an axis and rotatably movable around said axis, the winding body comprising a groove extending along said axis and being arranged on a lateral surface of the winding body for defining a hollow seat;
winding said web or discrete sheet around the winding body for defining a cylindrical body of paper material, wherein the end portion and tail portion face each other for defining a mutual overlapping portion;
constraining the end portion to the tail portion at the mutual overlapping portion for defining a straw extending between a first and a second circular free edges,
said mutual overlapping portion extending between the first and the second free edges of the straw along a rectilinear direction,
the method further comprising a step of ejecting the straw following the constraining step, said ejecting step providing to move the straw along the axis of the winding body between:
a first position wherein the straw surrounds the winding body; and
a second position wherein a portion of the straw exceeds beyond the extension in length of the winding body,
the step of moving the straw providing to actuate an ejection wheel having an axis of rotation orthogonal to the axis of the winding body, said ejection wheel being further movable with respect to the winding body between a distal position and an approached position, said ejecting step comprising the steps of:
moving the ejection wheel from the distal position to the approached position, the sheet material of the straw being interposed in contact between said ejection wheel and the winding body;
putting in rotation said ejection wheel around its axis of rotation for moving the straw along the axis of the winding body to determine its ejection;
moving the ejection wheel from the approached position to the distal position.

29. A method for manufacturing straws comprising the following steps:
providing a web of paper material or a discrete sheet of paper material, said web or discrete sheet extending between an end portion and a tail portion;
providing a winding body extending along an axis and rotatably movable around said axis, the winding body having a cross-section, according to a plane orthogonal to the axis, comprising a first semi-circular outline, defining a first distance from the axis, and a second rectilinear, concave or convex outline defining a second distance from the axis, the first distance being greater than the second distance;
winding said web or discrete sheet around the winding body for defining a cylindrical body of paper material, wherein the end portion and the tail portion face each other for defining a mutual overlapping portion;
constraining the end portion to the tail portion at the mutual overlapping portion for defining a straw extending between a first and a second circular free edges,
said mutual overlapping portion extending between the first and the second free edges of the straw along a rectilinear direction,
wherein the straw has a cylindrical shape defining an inner circumference,
the sum of an extension in length of said first and second outlines defining a dimension L lower than said inner circumference of the straw, wherein 0.5*IC<L<0.98*IC,
IC being the inner circumference.

30. Method according to claim 29, wherein the lateral surface of the winding body comprises a first surface having a semi-cylindrical shape, and a second surface extending for the overall length of the winding body and being flat or concave or convex with shape having a curve radius greater than a curve radius of the first surface.

31. Method according to claim 29, wherein the winding body further comprises a groove extending along the axis and defining a hollow seat, the winding step comprising the following sub-steps:
approaching the end portion of the web or discrete sheet to the winding body;
inserting a part of the end portion into the groove of the winding body;
after the inserting step, rotating the winding body around the axis and simultaneously thrusting said web or discrete sheet towards the winding body for determining the winding step.

32. Method according to claim 29, wherein the winding body has a first radial size, the method further comprising:
predisposing an auxiliary winding body extending along an axis and having a second radial size, the first radial size being different from the second radial size allowing to define straws having different diameters;
the method comprising the step of selectively guiding the web or the discrete sheet towards the winding body or towards the auxiliary winding body.
